(19) United States
(12) Patent Application Publication
(10) Pub. No.: US 2012/0317050 A1
(43) Pub. Date: Dec. 13, 2012

(54) METHOD, COMPUTER PROGRAM PRODUCT AND COMPUTER-READABLE STORAGE MEDIUM FOR THE GENERIC CREATION OF A STRUCTURE TREE FOR DESCRIBING AN IT PROCESS

(75) Inventor: Klaus Bermuth, Mainz (DE)

(73) Assignee: DB SYSTEL GMBH, Frankfurt am Main (DE)

(21) Appl. No.: 13/577,726

(22) PCT Filed: Feb. 3, 2011
(86) PCT No.: PCT/EP11/00501

§ 371 Date: Aug. 8, 2012

(30) Foreign Application Priority Data
Feb. 15, 2010 (DE) 10 2010 007 967.7

(51) Int. Cl. G06Q 10/06

(52) U.S. Cl. 705/348

(57) ABSTRACT

The invention relates to a method, to a computer program product and to a computer-readable storage medium for the generic creation of a tree structure for describing an IT method, comprising a complete environment composed of clients, servers, middleware components, applications and network components which an end user requires for carrying out a specific IT-supported business process. The invention is based on the generic creation of a tree structure for describing the topology of an IT method, by which tree structure it is possible to collect and manage all the data necessary for the overall handling of an IT method in a defined structure, such that all the procedures relevant for managing an IT method come from one data source and can be automated. The freedom from loops and the unambiguity of the elements result in a structuring of the data contained in the IT method, whereby automated processing is facilitated. A meta element type in the meta model is assigned to each of the elements used in the tree structure. The meta model describes which element types are allowed. The element types comprise all common generic IT components, such as server, middleware, storage, and the like. It is also established which attributes relating to the element types are allowed and/or necessary and which relations with the associated attributes are allowed between the elements. The freedom from loops is achieved by the use of an acyclically directed graph as the metastructure.

The invention pertains to a method, a computer program product and a computer-readable storage medium for the generic creation of a structure tree for describing an IT process, comprising a complete environment consisting of clients, servers, middleware components, applications and network components that an end user requires for carrying out a specific IT-supported business process.

An IT process is the completely installed, interconnected and, if applicable, activated environment consisting of clients, servers, middleware components, applications and network components that an end user requires for carrying out a specific IT-supported business process.

In its entirety, the invention makes available a solution for the overall handling of an IT process. This concerns
the automated installation of the IT process,
the company-wide architectural control,
the formation or the revision of service agreements for IT processes/IT services with end clients,
the technical installation of an IT process,
the reporting on the availability of an IT process and its elements,
the service-oriented monitoring and incident management of IT processes including the target group-appropriate allocation of malfunction notifications to the originator of a malfunction,
the definition and documentation of object-specific monitoring tasks in connection with an IT process.

In the management of IT processes, more or less detailed information on the technical interaction of the elements is required in different respects.

A number of applications are available for this purpose and support the user in the acquisition and management of such information.

Although the required correlations always describe an identical environment, the different observation angles are modeled separately of one another in the prior art. For example, the description for the IT process installation follows the sequence root node-IT process-server-middleware-application. For an IT process, the servers are initially installed. The middleware such as, e.g., a JEE application server is then installed on these servers and the actual client-specific application is subsequently installed on this middleware.

The description is realized differently in service-oriented monitoring. In this case, one follows the sequence root node-IT process-application-middleware-server. The end-to-end view of the user is expressed in this description. An IT process is malfunctioning when the client-specific application malfunctions. The application is unable to function if the middleware has a problem. On the other hand, the middleware is unable to function if the basic server does not function. In the formation of service agreements/service contracts with the end client, fine-grained correlations in and between the IT processes play a secondary role. However, the service quantities and also the service qualities to be rendered which affect the IT process operation are relevant in this respect. In order to allow the correct planning of these service quantities and service qualities, one requires information on the structure of the IT process and the qualities required for each element such as service quantities, service levels, etc.

For example, information models referred to as Common Data Models (CDM) have already been developed and attempt to deliver consistent definitions for the IT components, business systems and processes to be managed, wherein the relations between the elements are also taken into consideration (see, e.g., IBM Redpaper “IBM Tivoli Common Data Model: Guide to Best Practices”).

A CDM essentially consists of data definitions that are organized in a logical model and stored in a database in a predetermined fashion. In this way, resource instances can be identified and information on the instances and their relations between one another can be managed.

Business and infrastructure processes can be interrelated with the IT systems that render the service on the basis of the CDM. In this case, the data sets are combined, e.g., into groups that are divided into physical units, network, administration, storage, etc. The organization is realized in a hierarchic fashion by means of object classes and their instances. The hierarchy starts with a root element that contains the abstract classes, from which the logical and physical classes are derived. In this case, subclasses inherit the abstract properties of their superordinate parent classes. The instances of the classes ultimately represent the resources. The instances are assigned attributes that are specified for the corresponding class. Instances may furthermore be interrelated. Each relation between two resource instances obeys predetermined definitions depending on the type of relation. Numerous different relations may generally exist between identical classes and their instances.

Each instance represented in a CDM is assigned a name and an identifier, wherein a distinct name is assigned to each instance by utilizing certain name rules. The disadvantages of such a classic database-oriented design can be seen in that entirely different description structures exist for each element type. The element descriptions need to be very detailed in order to support management processes such as, e.g., installation processes based on a sophisticated individual description of the elements.

It is absolutely imperative to also acquire information that implicitly results or can be calculated for the modeling. For example, numerous details such as, e.g., the standard file systems of middleware components need to be modeled although they do not have to be modifiable from the perspective of the IT process. A technical server name can be created, e.g., by combining the following information:

IT process name+environment name+flag “used in cluster yes/no”+consecutive number (obtained by eliminating the prefix “server” from the label of the element “server 4711”)+network area of the public IP address (child element of the server)+server type (Linux, Solaris, Windows). In CDM, the name would have to be exactly defined in the description within the scope of the technical description of the IT process/server. Since information on child elements is also required in this case, however, the name cannot be obtained by inheritance only as it is the case in CDM.

Another example is an external formation rule with the specification that Apache web servers basically are installed in certain paths of a file system such as, e.g., /var/app. The information only forms part of the installation scripts of the IT process. In fine-grained CDM modeling, it would also be completely modeled because the CDM process is unable to recognize this information although it is already implicitly available. The CDM processes furthermore do not distinguish between the elements of the IT process technology and the basic platform elements that are usually assigned to different areas of responsibility. In the prior art, the data administration therefore is correspondingly elaborate and prone to errors. Due to the type of modeling, it also cannot be precluded that erroneous logical operations between instances or classes result in the creation of endless loops that significantly impair the ability to generically evaluate the structural information.

It is the objective of the present invention to make available a method for the generic creation of a structure tree for describing the topology of an IT process, wherein said method makes it possible to collect and manage all information required for the overall handling of an IT process in a defined structure such that all operations relevant to the management of an IT process draw upon one data source and can be automated. The inventive method aims to optimally support the compiling of all technical parameters of IT processes in such a way that the basic information for the commercial handling of the ordering process, the installation of the IT process, the monitoring of the provided IT process and the planning of new release versions can be homogenously realized with a uniform data structure. According to the invention, the description of an IT process is realized in a predetermined sequence, namely such that already acquired information is preserved. If technical values for the description of an IT process can be determined or calculated from other already acquired description values of the IT process (inside and outside the structure tree), it is proposed, according to the invention, to forgo the description of these technical values.

The determination of these values by far exceeds the scope of the conventional inheritance of properties between parent and child elements in processes according to the prior art.

It furthermore is an objective of the invention to make available a device that comprises a storage medium with a program stored thereon, wherein said program can be read by a data processing system and enables the data processing system to collect and manage all information required for the overall handling of an IT process in a defined structure such that all automatable operations relevant to the management of an IT process can be carried out in an automated fashion by the data processing system.

These objectives are attained with the inventive method according to Claim 1, a machine-readable storage medium according to Claim 15 and a computer program product with the program code stored on a machine-readable medium according to Claim 16.

Advantageous enhancements of the invention form the objects of dependent Claims 2 to 14.

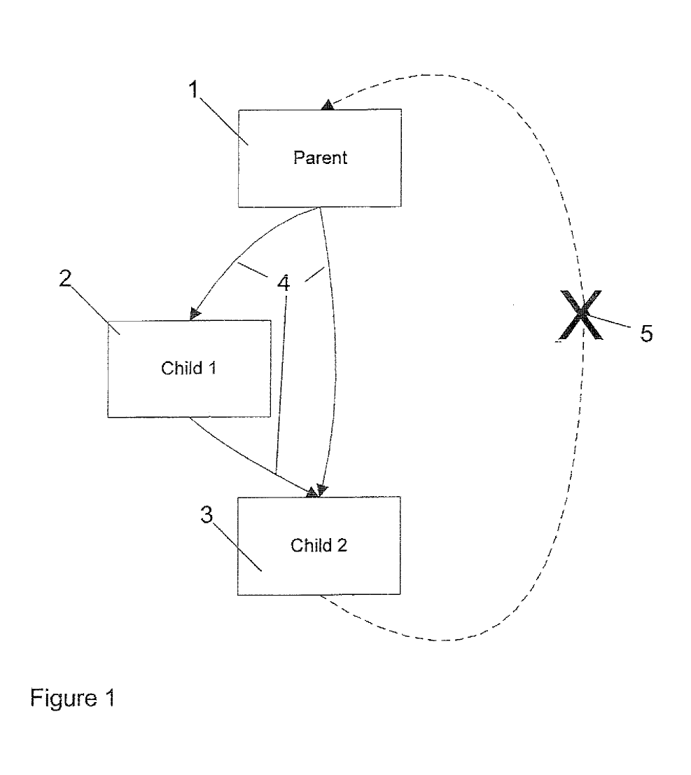

In order to elucidate the invention, the respective correlations are illustrated in the form of diagrams in FIGS. 1 to 28.

FIG. 1 shows an illustration of the permitted parent-child relations on the basis of an acyclically directed graph. The parent element Parent (1) has 2 children, namely Child 1 (2) and Child 2 (3). Child 2 (3) is also a child of Child 1 (2). It is not permitted to set up (5) the parent element Parent (1) as a child (or even grandchild) of its child element Child 2 (3) because a loop would otherwise be created.

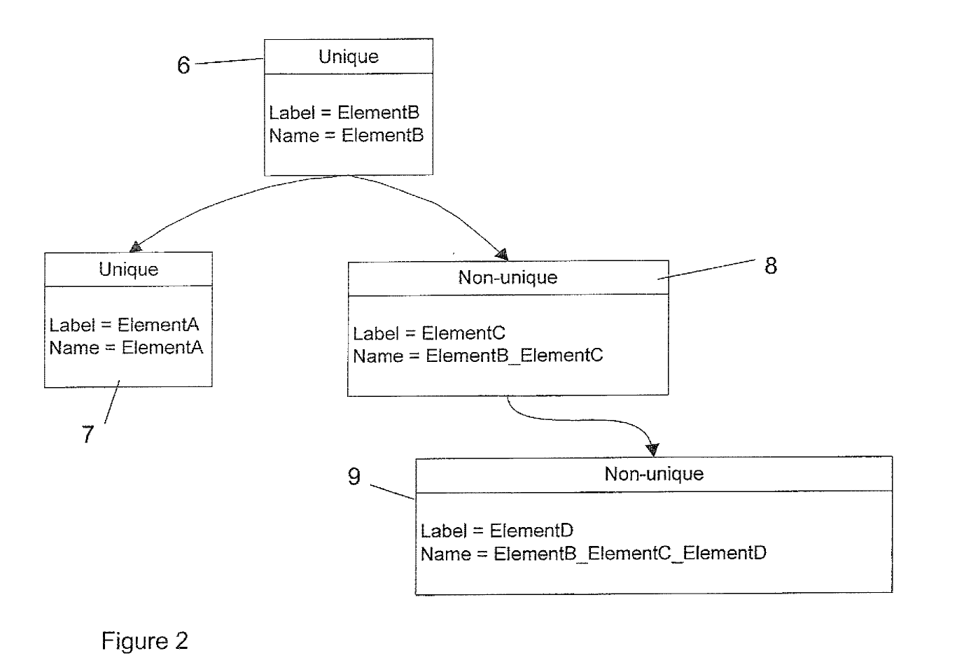

FIG. 2 shows how the names are distinctly created for unique and non-unique elements. In this case, the term “label” refers to the proper name of the element. For non-unique elements (8, 9), the complete name is formed of the proper name and the names of the superordinate elements.

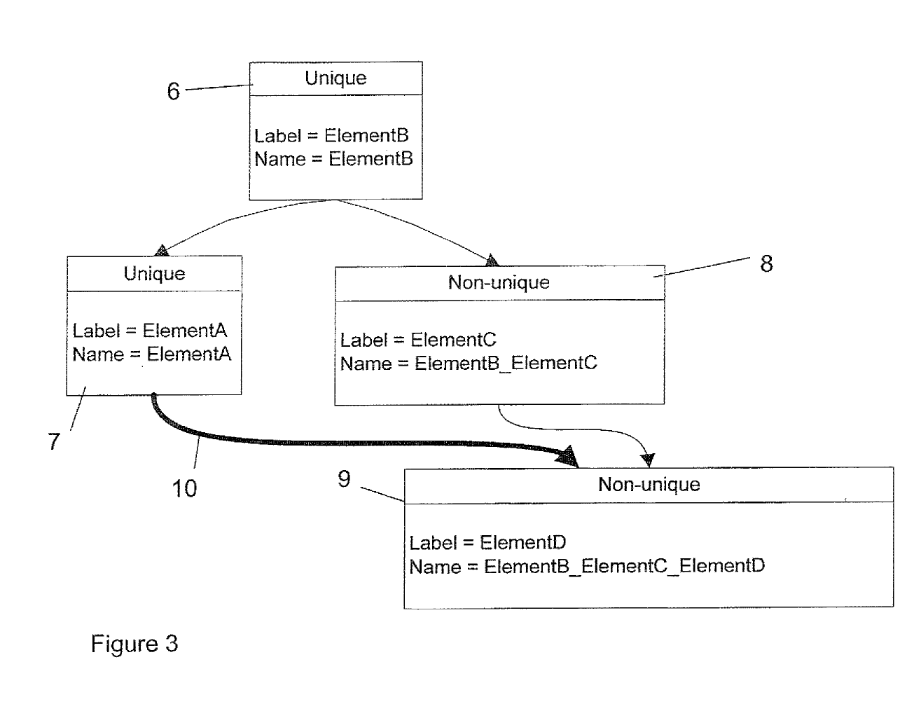

FIG. 3 emanates from FIG. 2 and shows an illustration of a reference (10) to an element (9).

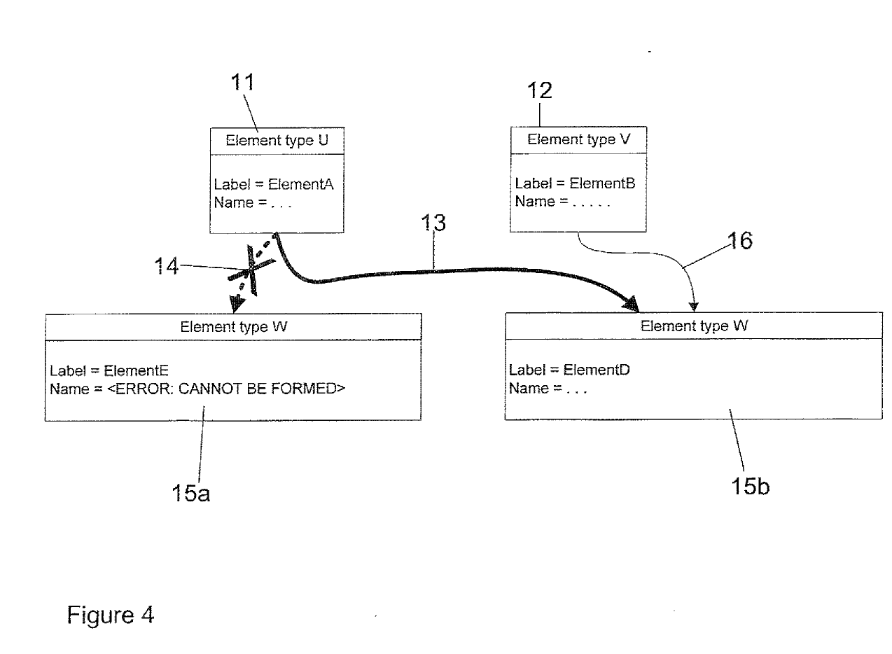

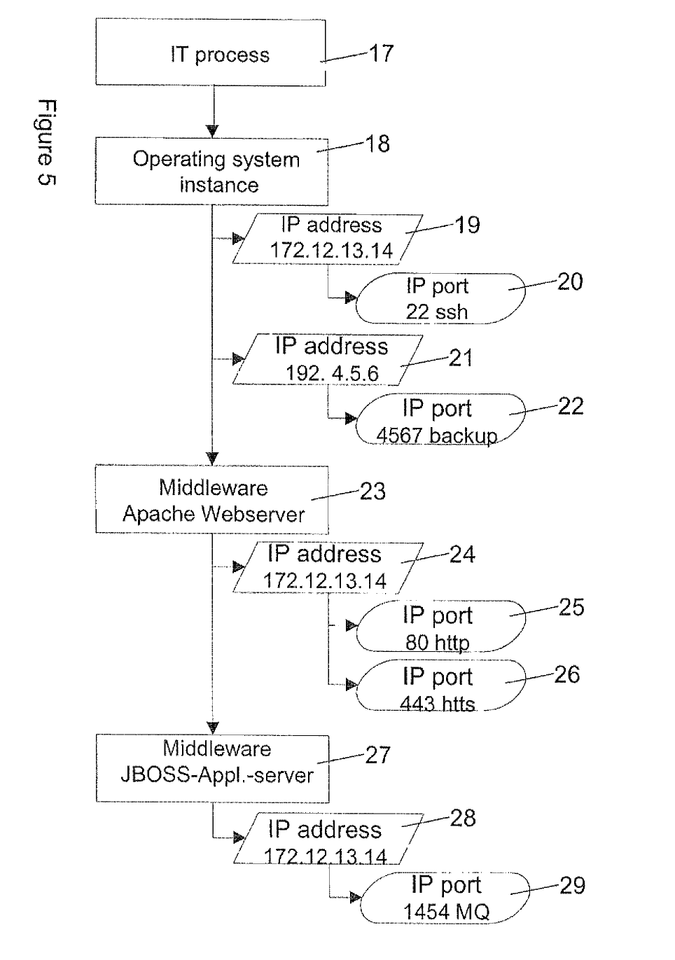

FIG. 4 shows an illustration of primary and secondary relations. In secondary relations (13) that refer to a child element from a parent element, the child element already needs to be set up with a primary relation (16) to another parent element, wherein a secondary relation is otherwise not permitted (14). In the illustration, the thin line symbolizes a primary relation (16) and the thick line symbolizes the secondary relation (13).

FIG. 5 shows an illustration of details in the structure tree of an IT process (17) using the example of the IP addresses (19, 21, 24, 28) and IP services/IP ports (20, 22, 25, 26, 29).

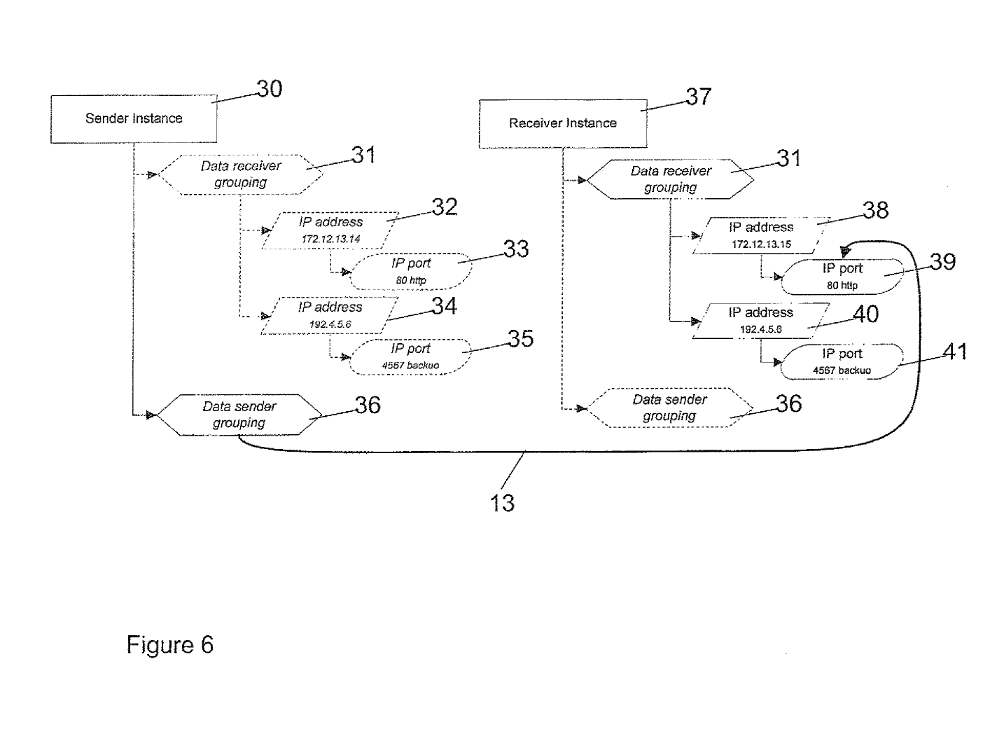

FIG. 6 shows the modeling of a data link by means of a secondary relation (13). The sender instance (30) sends data to the IP address 172.12.13.15 (38), port 80 (39) of the receiver instance (37). The data link is described as secondary relation (13) because only one existing destination port can also be addressed and this port only exists if the receiver instance also exists.

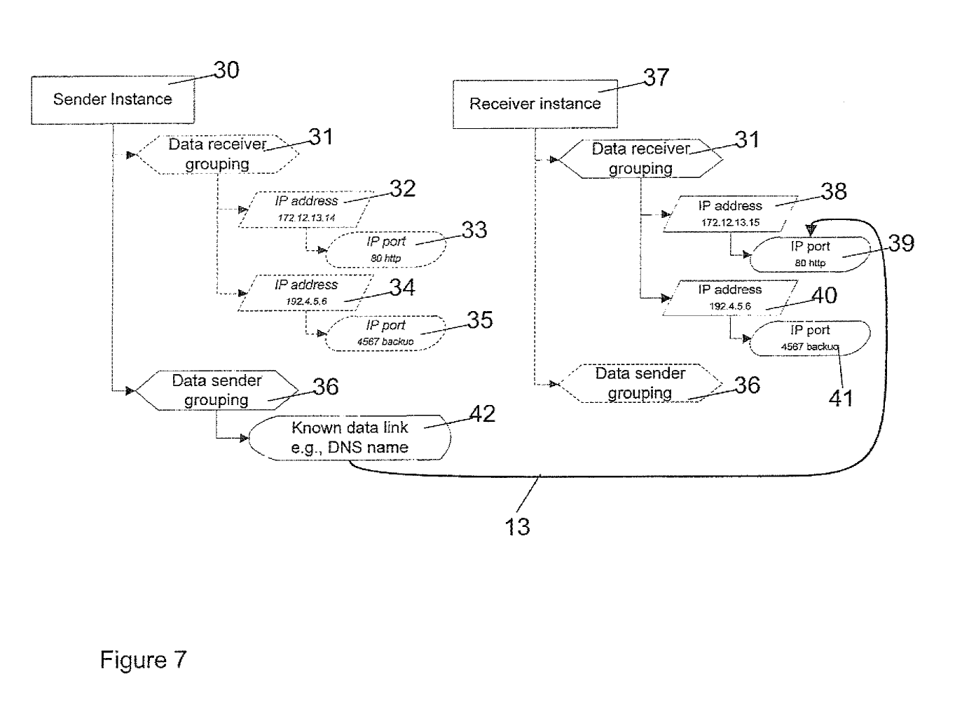

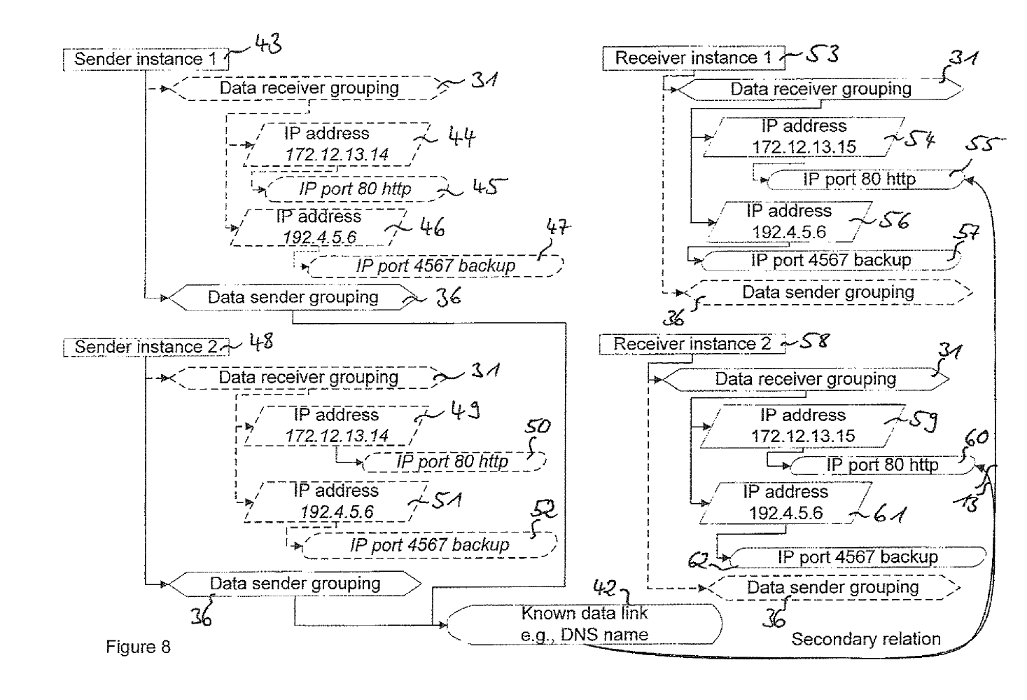

FIG. 7 is derived from FIG. 6 and shows the designation of a data link by means of a separate element (42). This is required, e.g., for describing data links with DNS name resolution.

FIG. 8 is derived from FIG. 7 and shows several senders (43, 48) that send data to several receivers (53, 58) via a DNS link (42). For this purpose, the designated data link is assigned to several parent objects (36) that are grouped within different sender instances (43, 48) in the form of data senders. The DNS service itself is not illustrated in the figure.

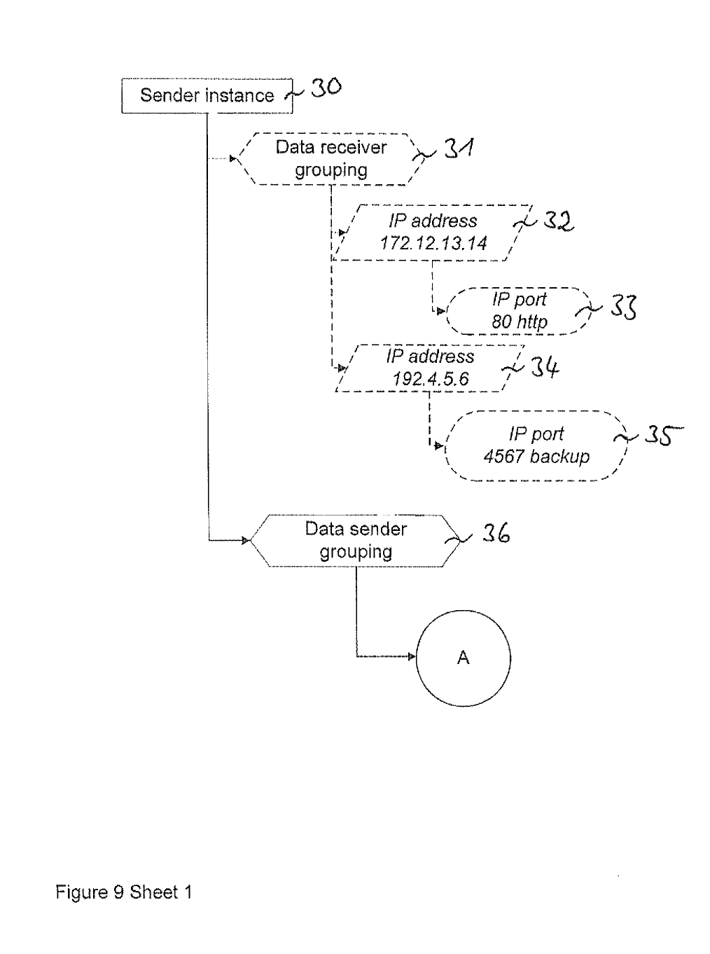

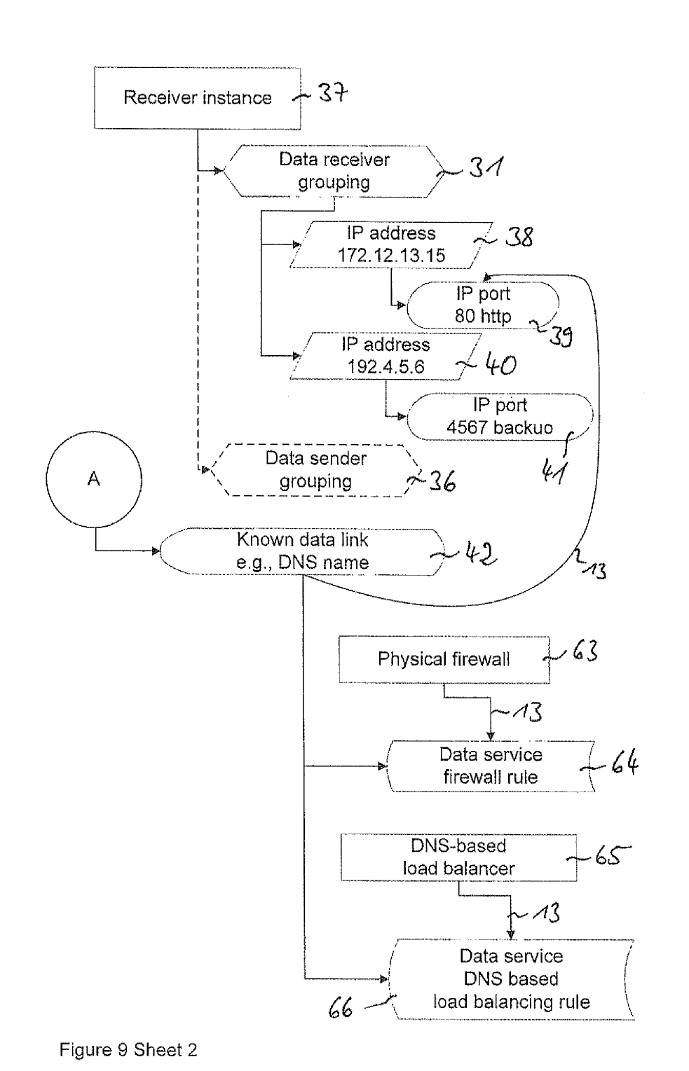

FIG. 9 shows the modeling of network services that influence a data link. The exemplary data services of a firewall rule (64) and a load-balancing rule (66) illustrated in this figure are set up as child elements of a designated data link (42) and associated with the elements of the corresponding physical components (63, 65) by means of secondary relations (13).

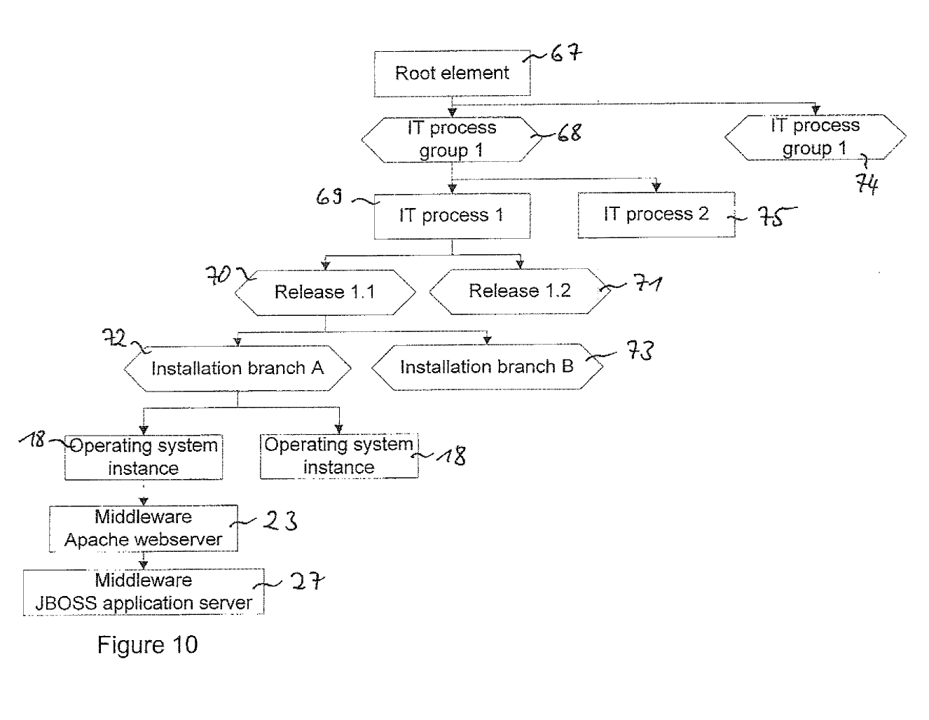

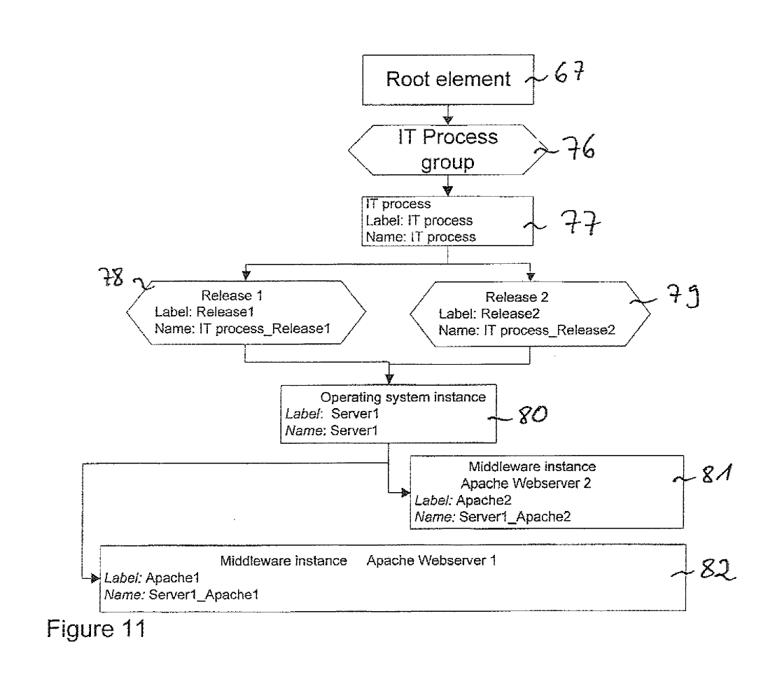

FIG. 10 shows how grouping elements are inserted. The grouping elements for the two IT process groups (68, 74), the two releases (70, 71) of the IT process 1 (69) and the two installation branches A (72) and B (73) belonging to release 1.1 (70) are illustrated hexagonally in this figure.

FIG. 11 shows an illustration of an IT process (77) with two releases (78, 79), in which the middleware instances (81, 82) are respectively designed differently. An Apache (82) is installed on a server (80) that is used in release 1 (78) and release 2 (79). In release 2 (79), however, the Apache 2 (81) is installed on this server as an additional Apache. If the server (80) is uniquely modeled as illustrated in FIG. 11, the fact that Apache 2 (81) only belongs to release 2 (79) respectively cannot be illustrated or only illustrated by means of additional relations between the middleware instance and the release or by means of attributes.

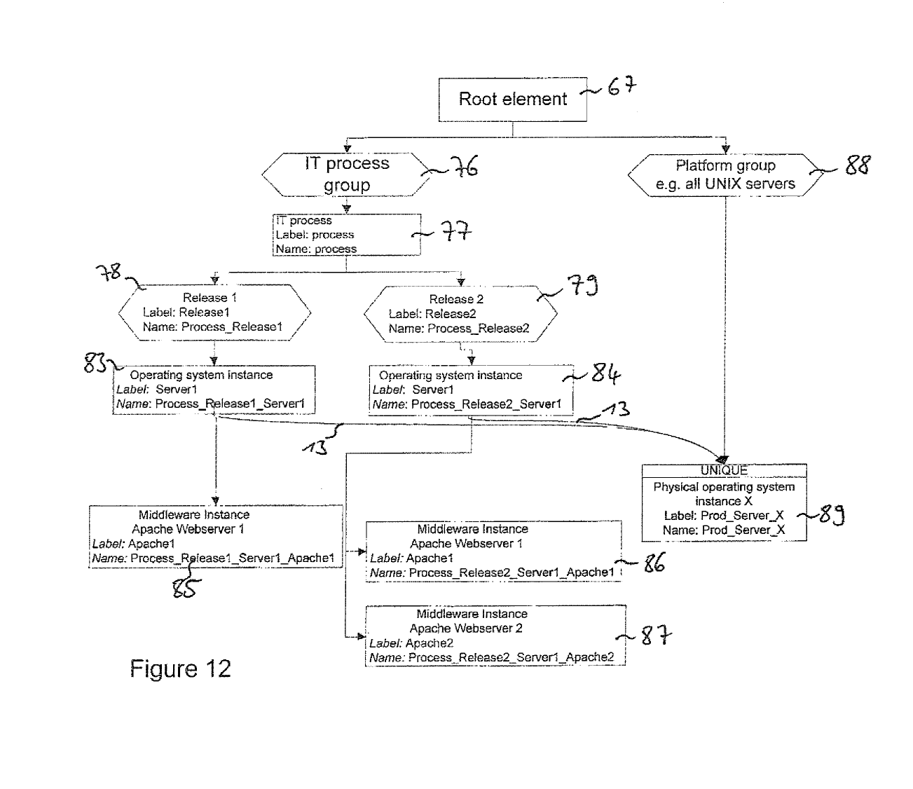

FIG. 12 shows the inventive combined solution to the problem defined in the description of FIG. 11. On the left side, the server is non-uniquely modeled (83, 84) in the two releases in order to thusly illustrate the IT process correlation. It is then associated with the uniquely modeled physical server (89), of which only one exists company-wide, in the platform tree (88) by means of a secondary relation (13).

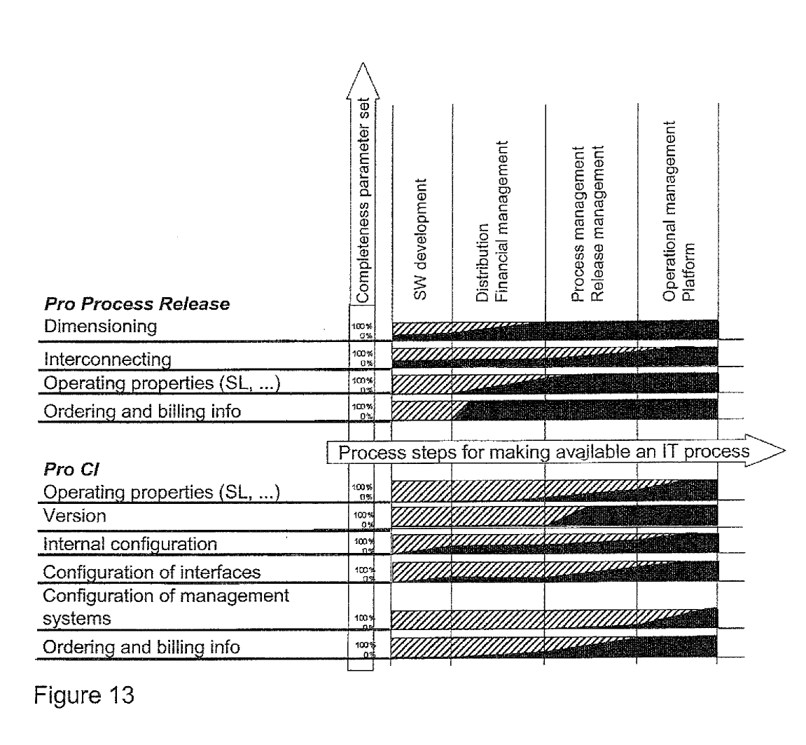

FIG. 13 shows in the form of a diagram how the information required for the complete installation of the IT process is successively provided while the process steps for making available an IT process are carried out. The information to be described is respectively listed on the left side and the respective information provider is listed on the top. Hatched areas symbolize missing information while the information in black areas is complete.

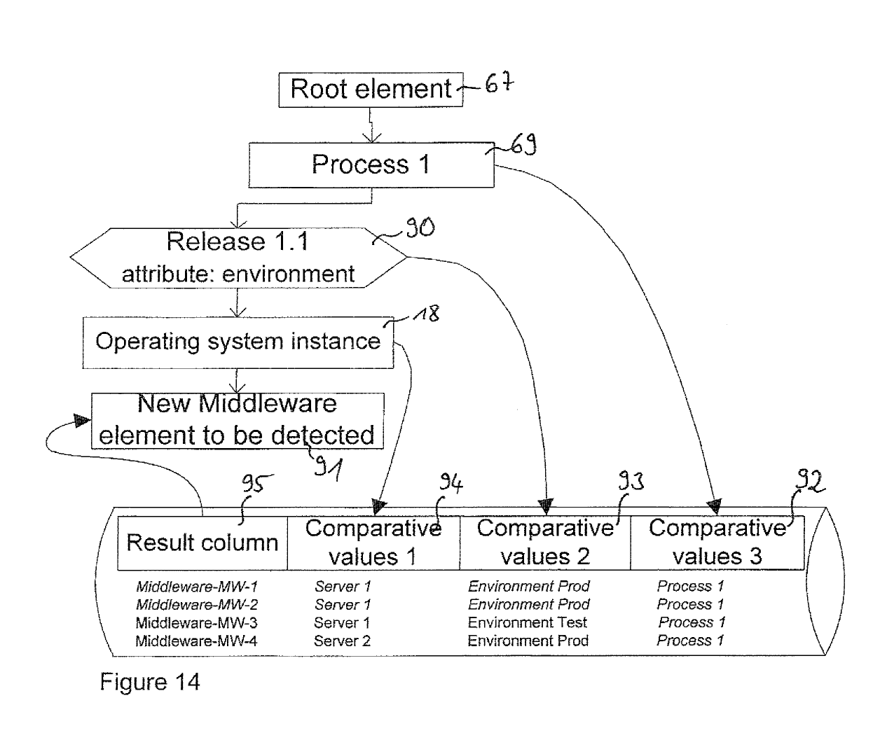

FIG. 14 shows how a Value-Source mechanism limits the choices of names and/or attributes during the acquisition of new elements based on information that already exists in the structure tree above the element.

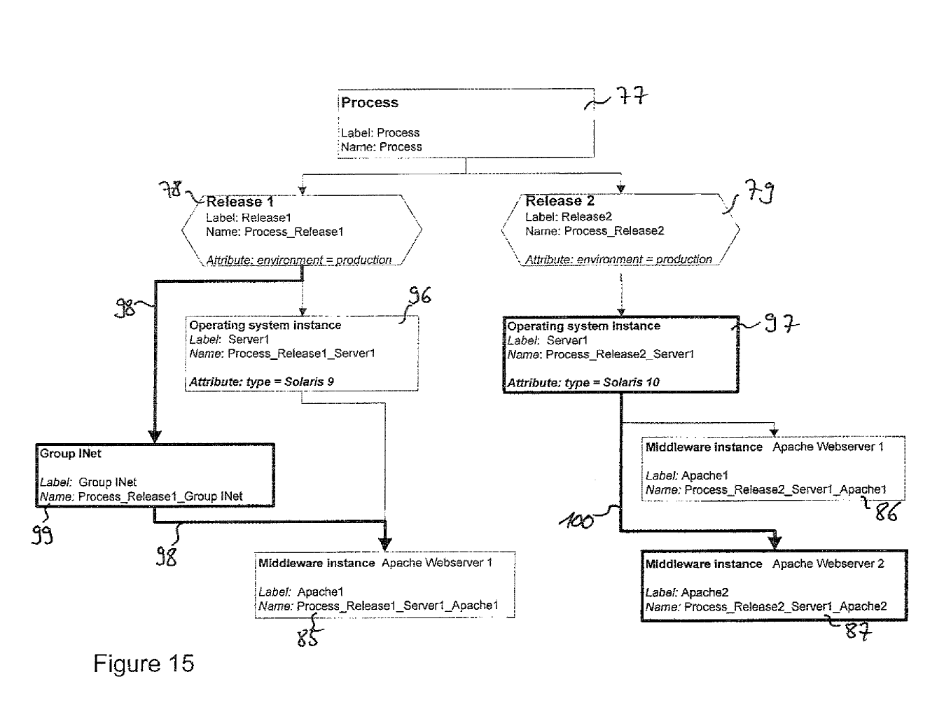

FIG. 15 shows the differences detected during a comparison of two exemplary releases (78, 79). Changes such as the deconstruction of the group INet (99) with the parent and child relations (98), the addition of the element Apache webserver2 (87) with the relation (100) and the change of the attribute type from “Solaris9” to “Solaris10” in the element served (96, 97) are respectively illustrated in bold face.

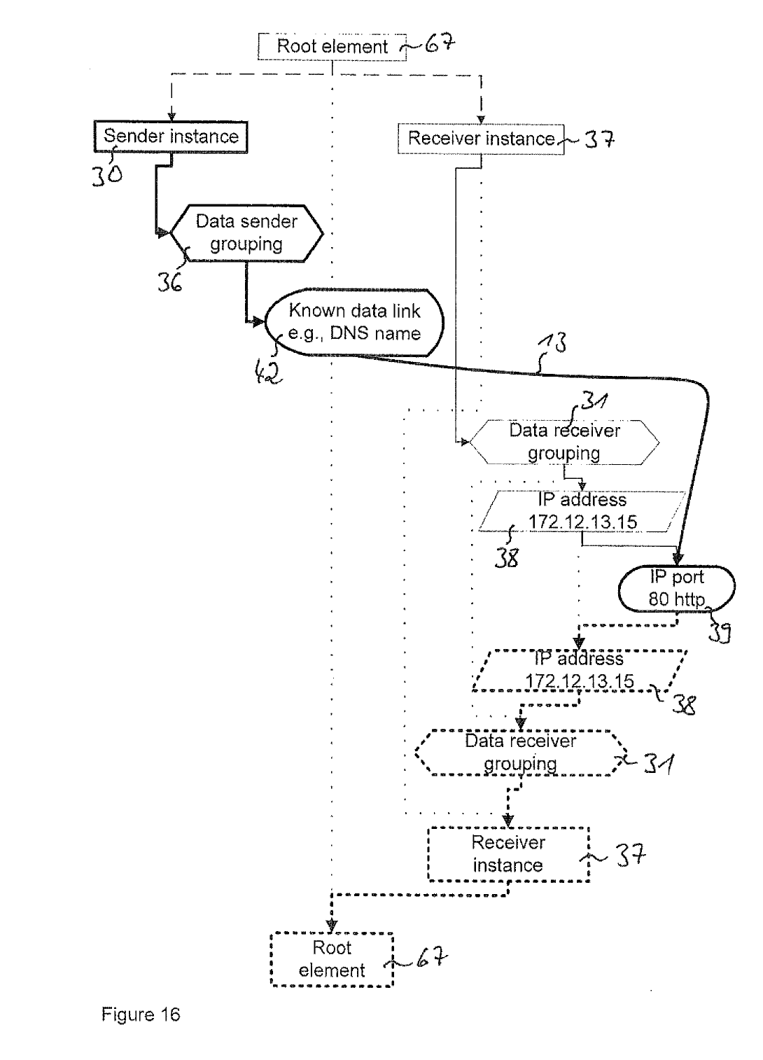

FIG. 16 shows an example of the export of substructure trees. The substructure tree of the sender instance (30) shown is acquired up to its final element “designated data link” (42) and then associated with the receiver instance (IP port, 39) by means of a secondary relation. Within the definition of the meta-relation to relation (13), it is uniquely specified for all these special meta-relations that the export of the tree contains an upwardly directed mirror image from the child element (in this case IP port, 39) onward. This is the reason why the upwardly directed substructure tree is also exported up to the receiver instance (37) and to the ROOT (67). The export now contains all information required for modeling the data link. The information on the destination IP address (38) and the receiver instance (37) that would be missing without this upwardly directed export is now available in the export.

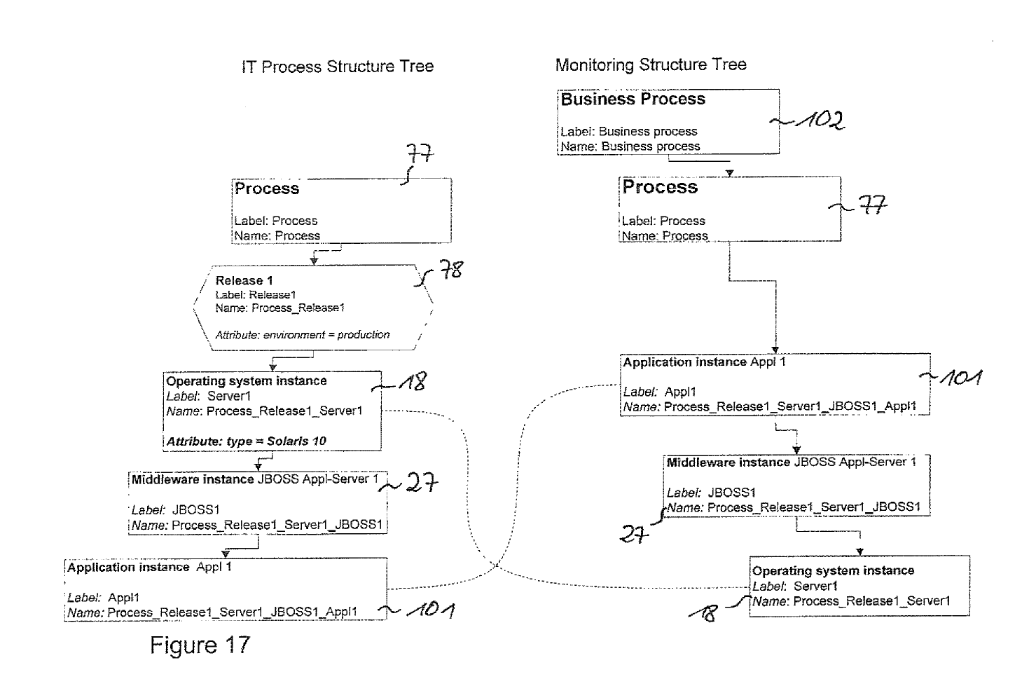

FIG. 17 shows how the IT process installation and the monitoring of the IT process access the same data set although they represent different structure trees. In comparison with the illustration for the IT process installation (left), the illustration of the structure tree for the monitoring (right) is inverted (see the positioning of the elements 18 and 101). Both structure trees may contain additional grouping elements that are not relevant to the conversion and, if applicable, need to be added in a different fashion (elements 78 and 102).

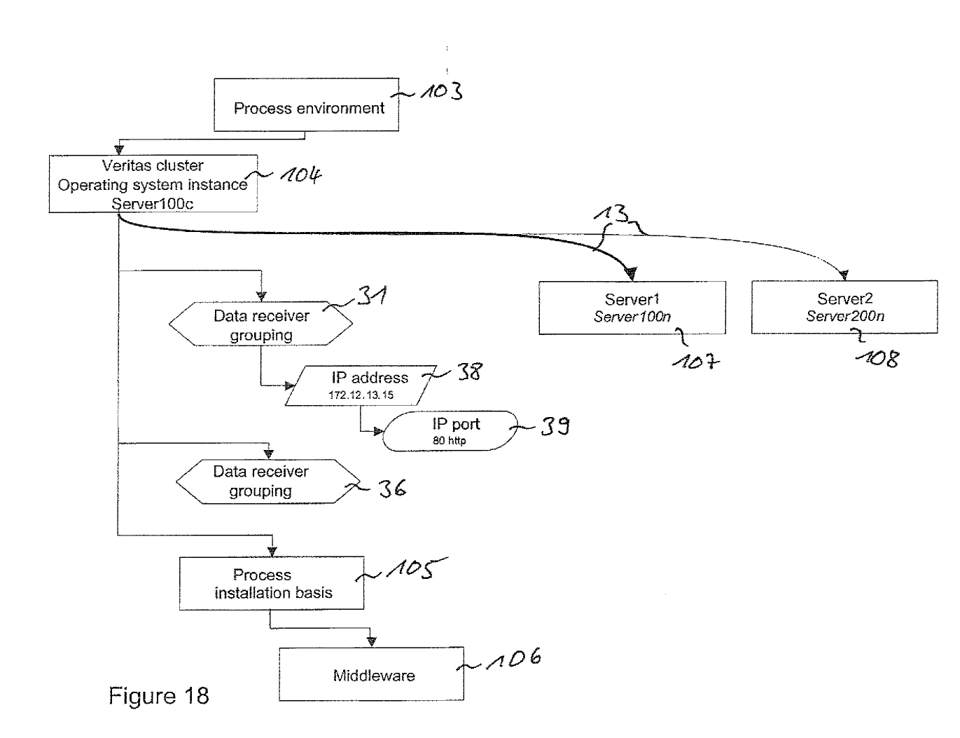

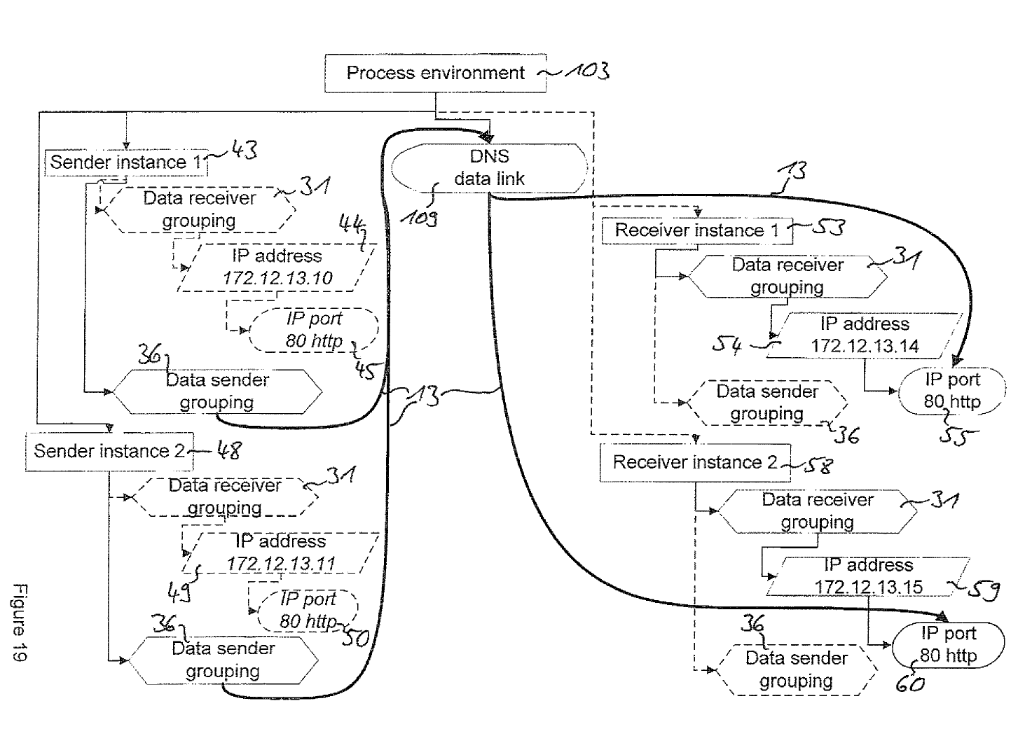

FIG. 18 shows in an exemplary fashion how a cluster of the type a (e.g., Veritas) is illustrated. In this case, Veritas is installed on 2 servers (107, 108) and then makes available an independent operating system instance (104) for the processes. This operating system instance is then conventionally utilized by the processes, i.e., a process installation basis (105) (file systems with groups and privileges) is set up and the (not-shown) middleware components (16) and application components are then installed therein. The servers may consist of logical servers, as well as virtual servers. The servers already need to be set up before Veritas is installed. This is the reason why the association is respectively realized in the form of a secondary relation (13).

FIG. 19 shows the exemplary illustration of a cluster of the type b. The data sender (sender instance1 43 and analogously sender instance2 48) addresses a DNS farm address (109). The DNS load balancing service (the not-shown network device, in which the DNS address 109 is resolved) selectively returns the IP address 172.12.13.14 (54) or 172.12.13.15 (59) as destination. In this way, the receiver instances 1 (53) and 2 (58) are alternately addressed.

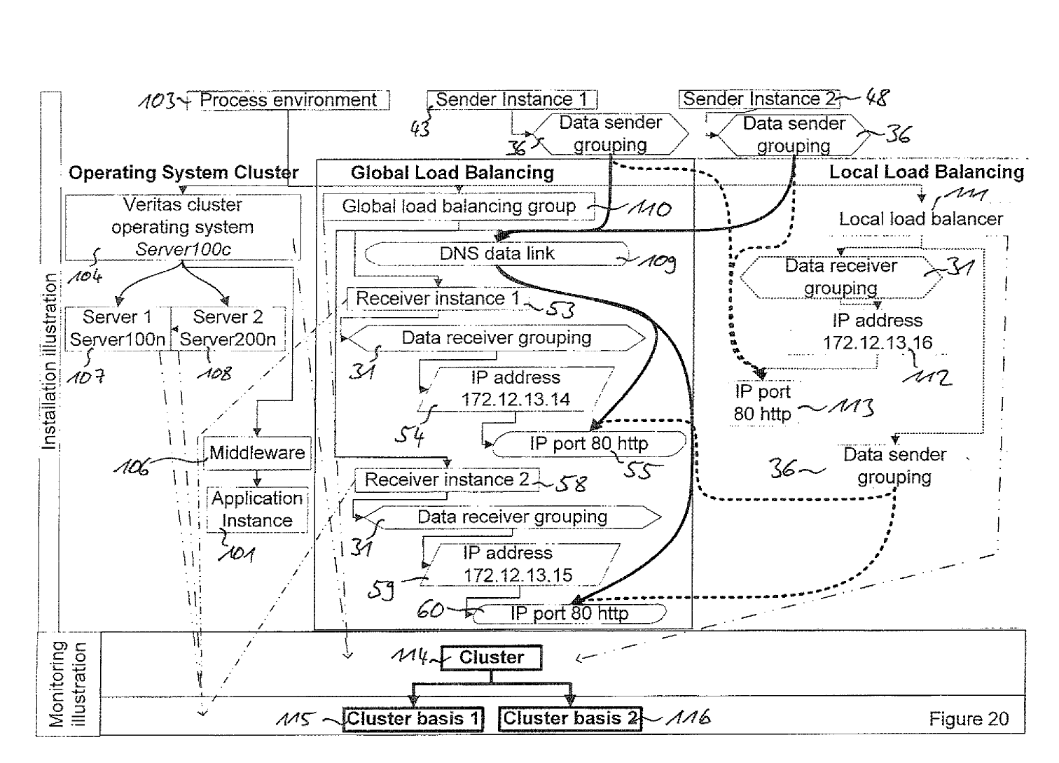

FIG. 20 shows how the exemplary clusters according to FIGS. 19 and 20 are mapped on the monitoring structure tree. In the 3 variations of cluster descriptions (operating system cluster, global and the local load balancing), the elements (104), (110), (111) for the monitoring are compiled in the parent element “cluster” (114).

In this case, the instances of these cluster elements (115)/(116) respectively are the elements (107)/(108) and (53)/(58). This information can be directly derived from the installation structure tree for the operating system cluster, but needs to be indirectly determined by evaluating the respective data links (109) and (36) for both other load balancing types.

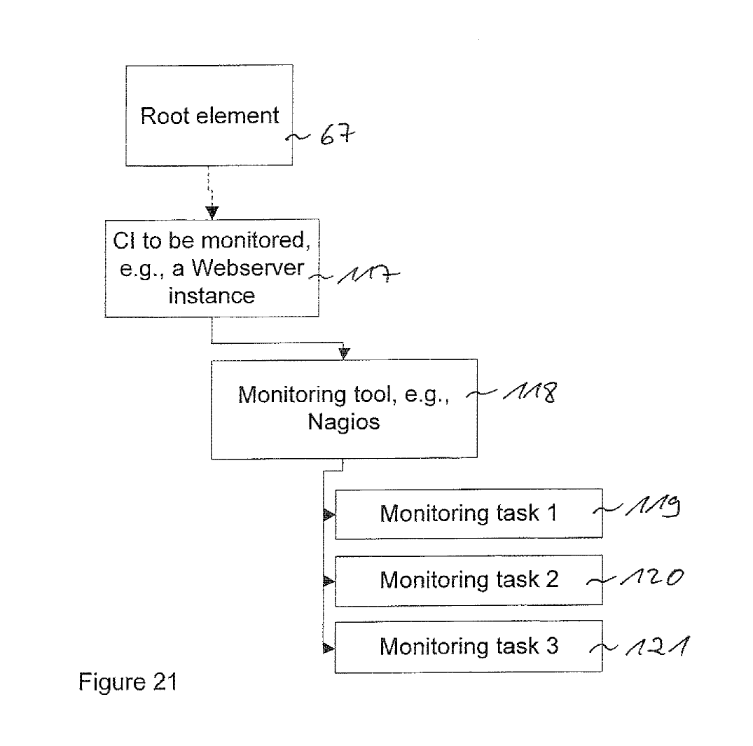

FIG. 21 shows the modeling of an element-specific monitoring process using the example of a webserver (117).

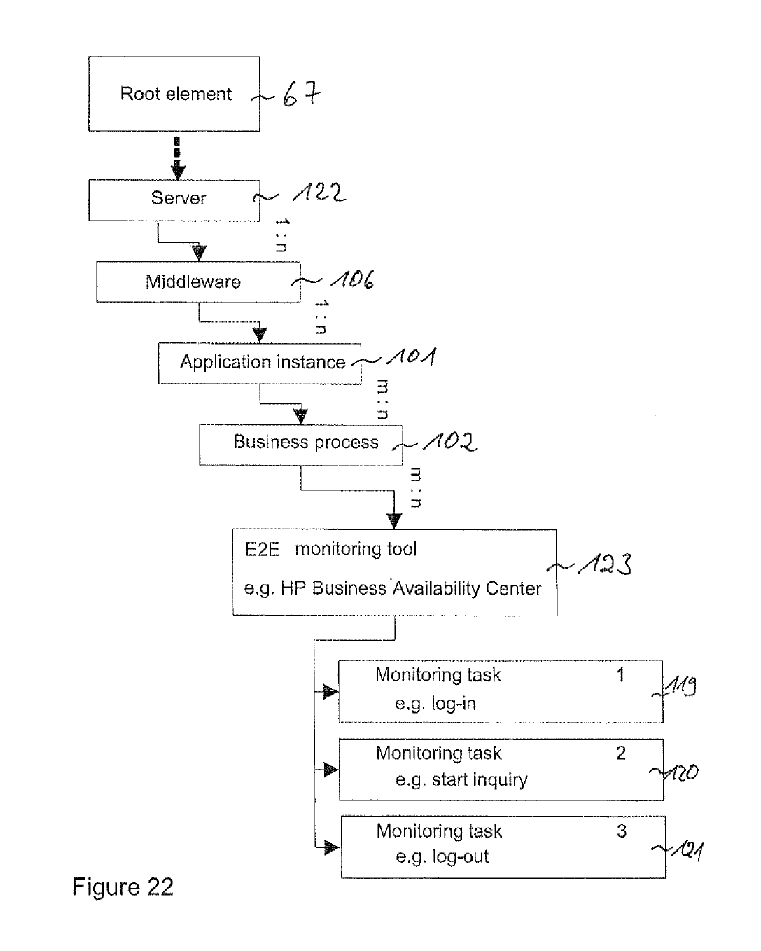

FIG. 22 shows in an exemplary fashion how the respective application components (101) of an IT process can be assigned to the business processes (102) of a user that can subsequently be monitored with end-to-end monitoring tools (123).

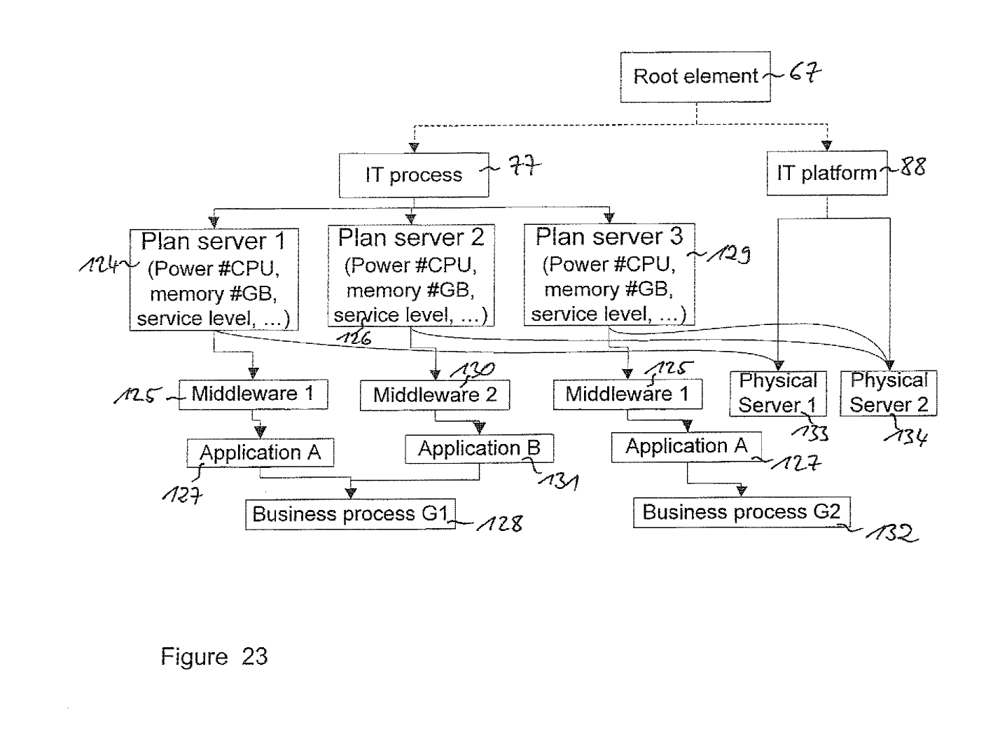

FIG. 23 shows how the IT process with, among other things, the required quantities and qualities of the servers (124, 126, 129) is planned with the aid of the substructure tree “IT process” (77). The assignment to the exact physical instances (133, 134) is realized by means of the subtree “IT platform” (88).

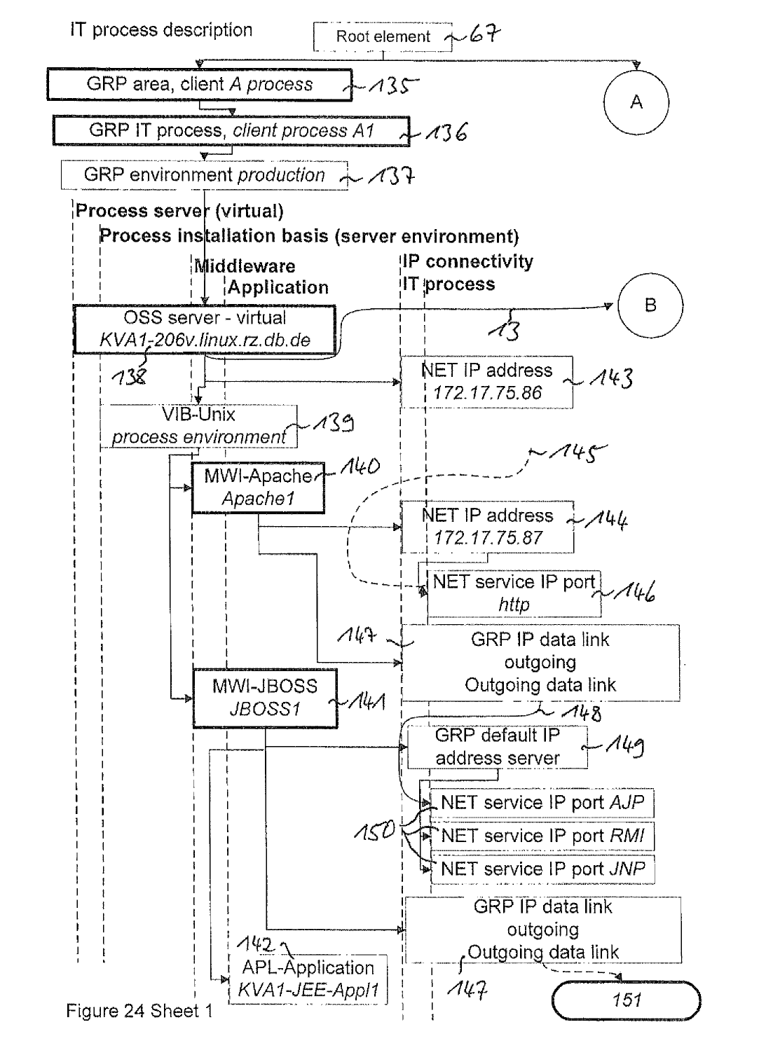

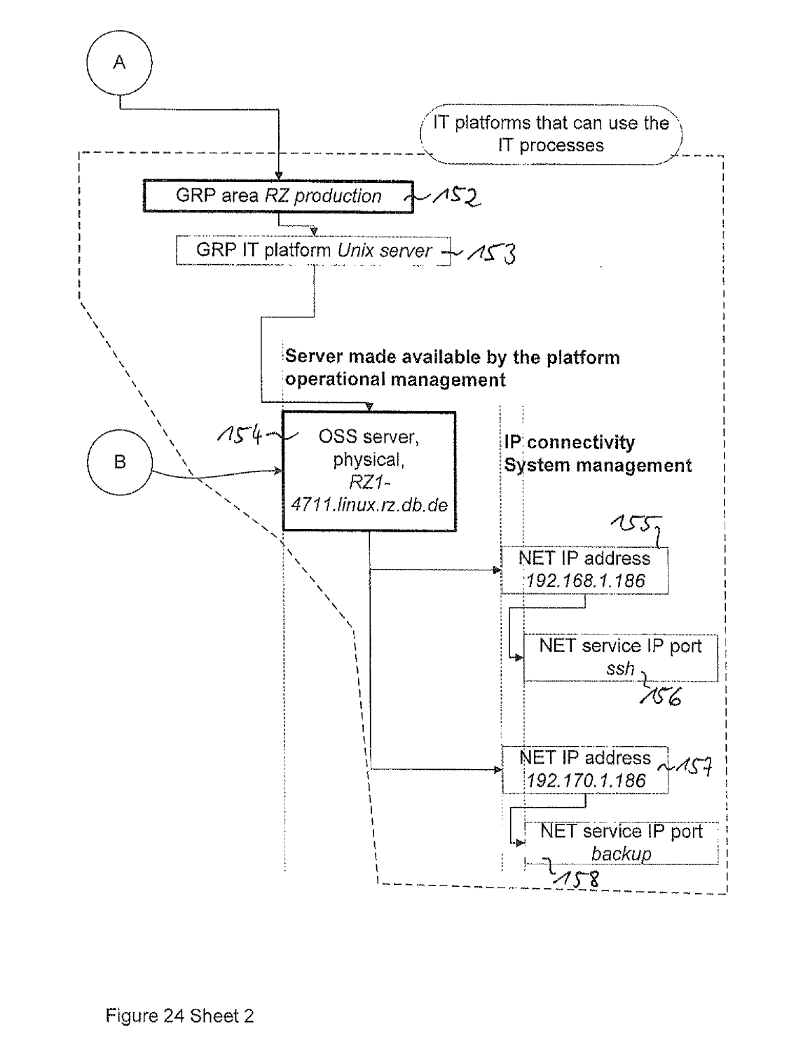

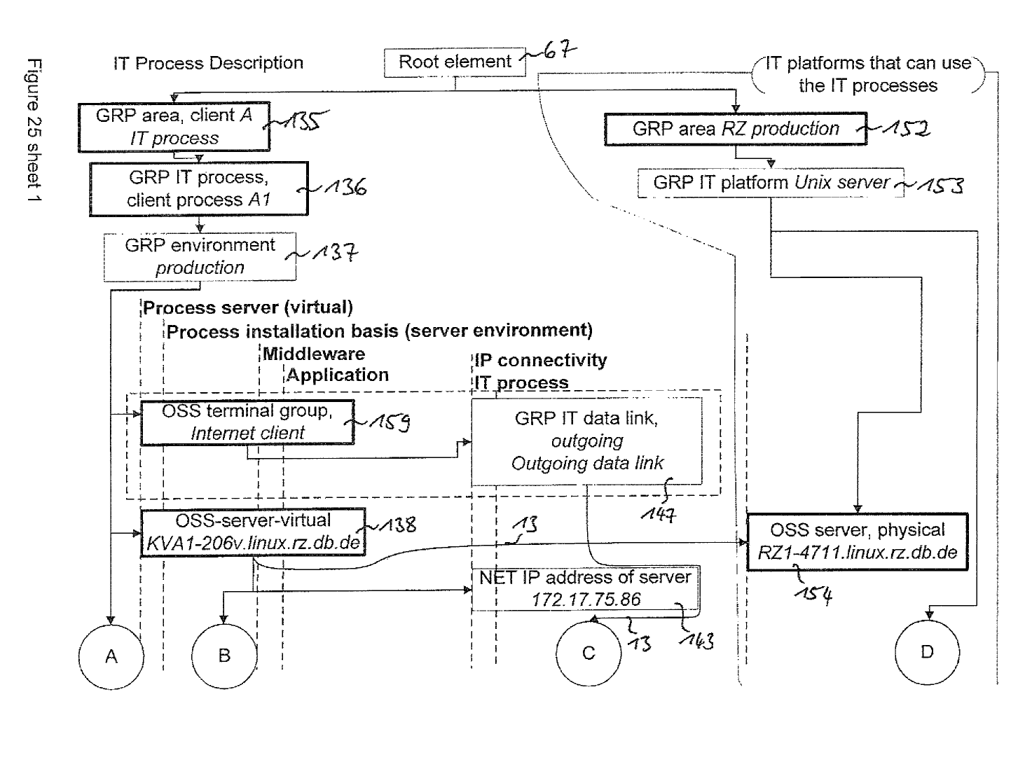

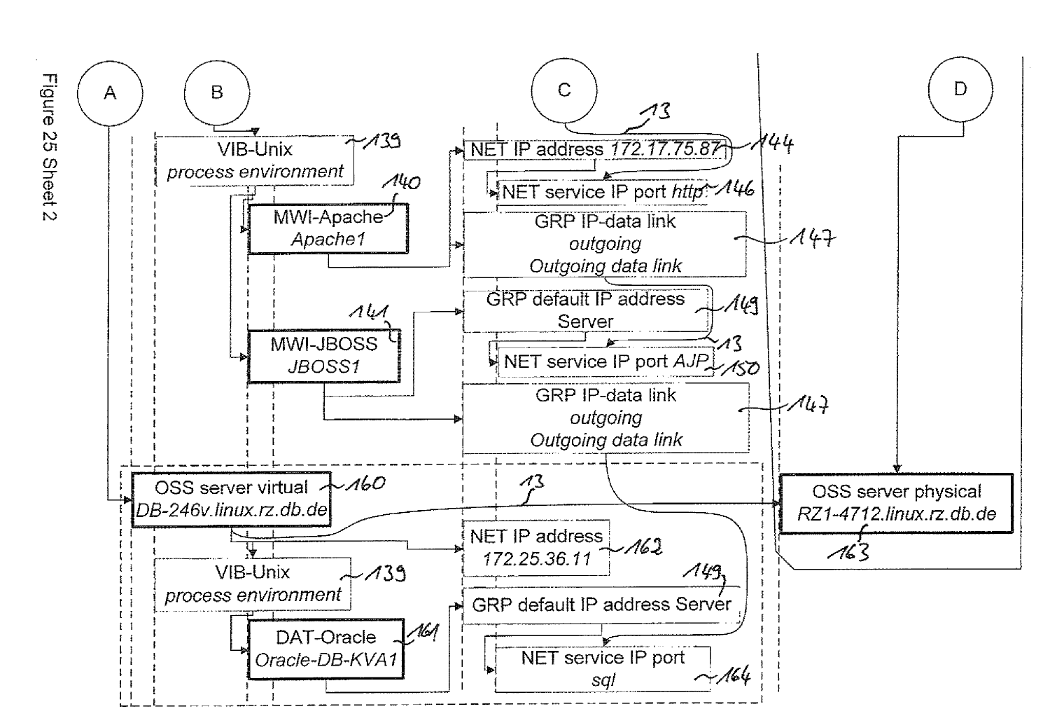

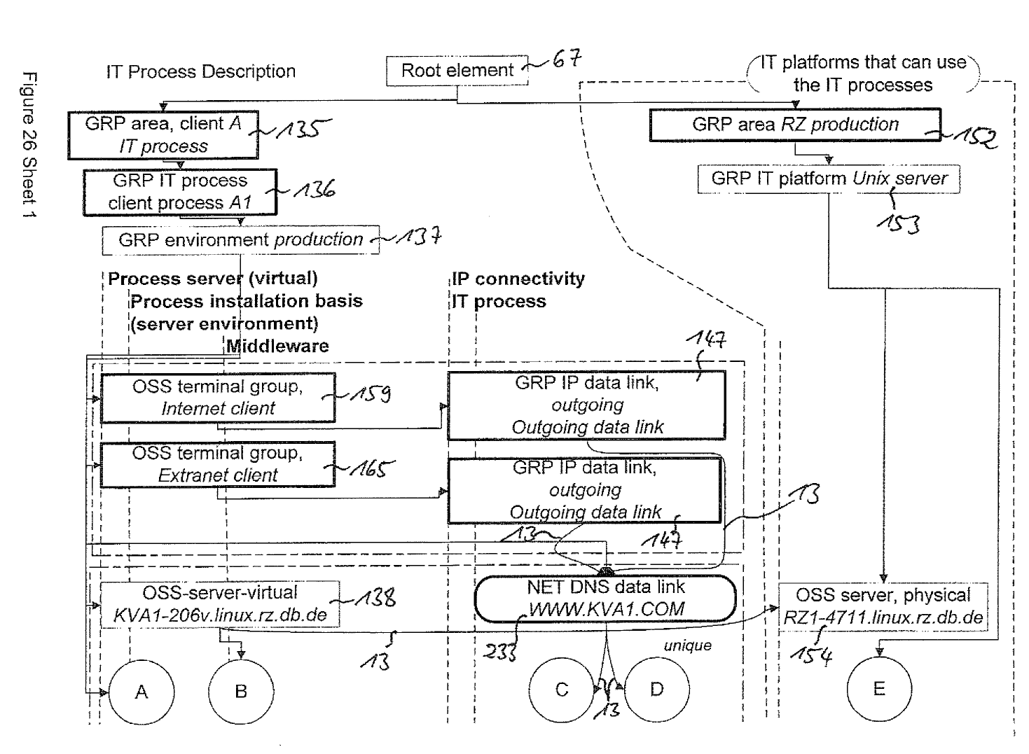

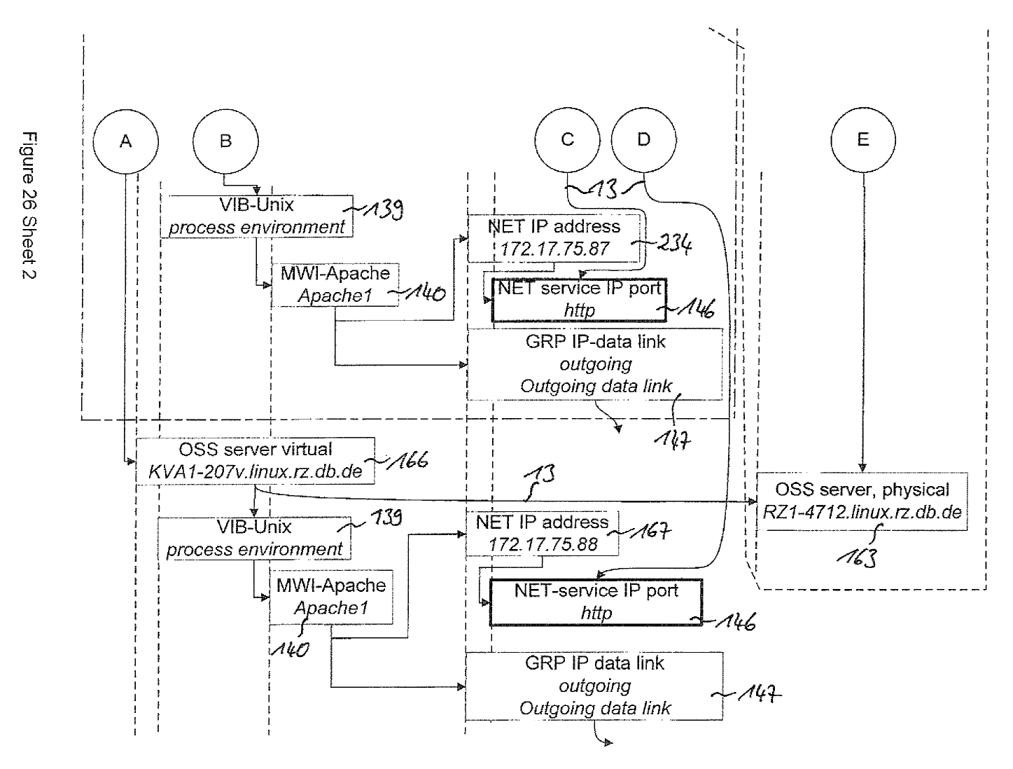

FIG. 24 shows a simple IT process that makes available two middleware components (Apache 140 and JBOSS 141) that are associated with one another (148) on a virtual server (KVA1-206v, 138). The virtual server is assigned to a physical server (RZ1-4711.linux, 154) by means of a secondary relation (13).

FIG. 25 shows an IT process according to FIG. 24 that was expanded by the database Oracle DB-KVA1 (161). Furthermore, the terminal group (159), i.e., the user of the IT process, is illustrated as a client of the type OSS terminal group. In this case, the secondary relations (13) show the data links from the terminal (159) to the webserver (140), from the webserver (140) to the application server JBOSS (141) and from the application server (141) to the database (161).

FIG. 26 shows how two different client groups (Internet 159, Extranet 165) access a webserver farm (140) via the DNS address www.kva1.com (233). The load balancing is controlled by the DNS service. The parameters required for this purpose (e.g., load balancing process round-robin, . . . ) are stored in the form of attributes in the DNS data link (233). The DNS name is the responsibility of the IT process and globally distinct. The DNS name therefore is uniquely modeled and the primary child of the IT process environment (137). The data links (147) utilize these names by means of secondary relations (13), in this case the relations between the elements (147) and (233).

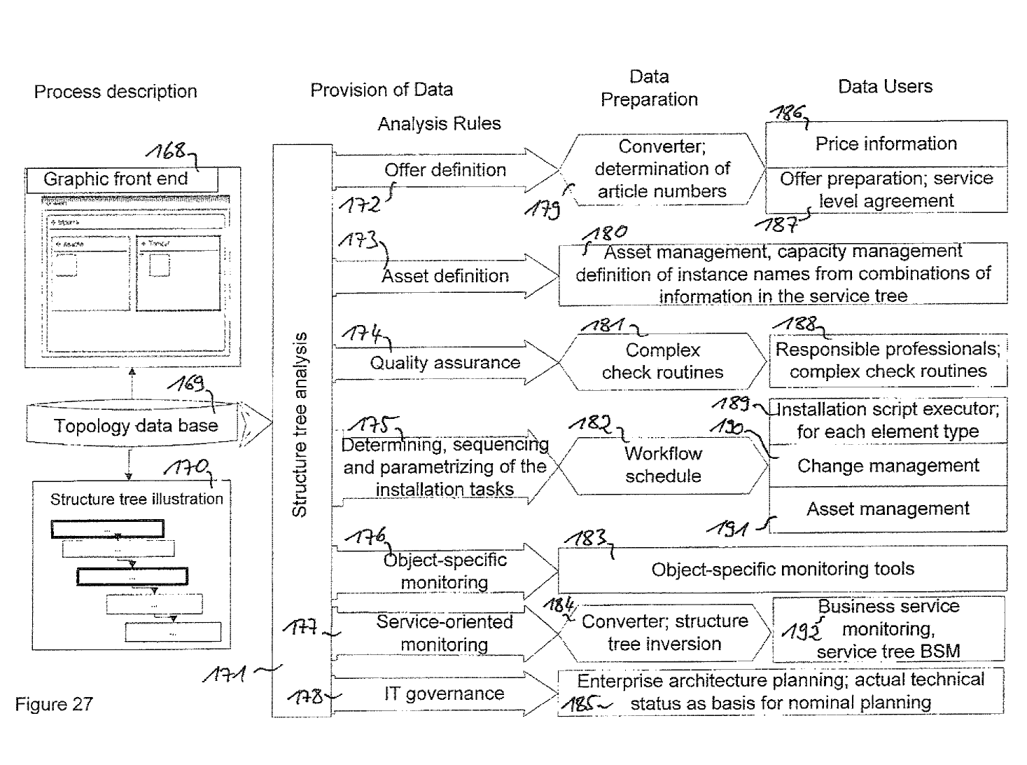

FIG. 27 shows the utilization of the information of the structure tree in several destination systems. Data for the offer definition (172), the asset definition (173), the quality assurance (174), the determination, sequencing and parameterizing of installation tasks (175), the object-specific monitoring (176), the service-oriented monitoring (177) and the IT governance (178) are made available by the structure tree of the IT process description illustrated on the left with the aid of analysis rules (172 to 178). The data is prepared accordingly (in this case illustrated at 179, 181, 182, 184 and, if applicable, also other instances) and made available to the suitable data users (186, 187, 180, 188, 189, 190, 191, 183, 192, 185).

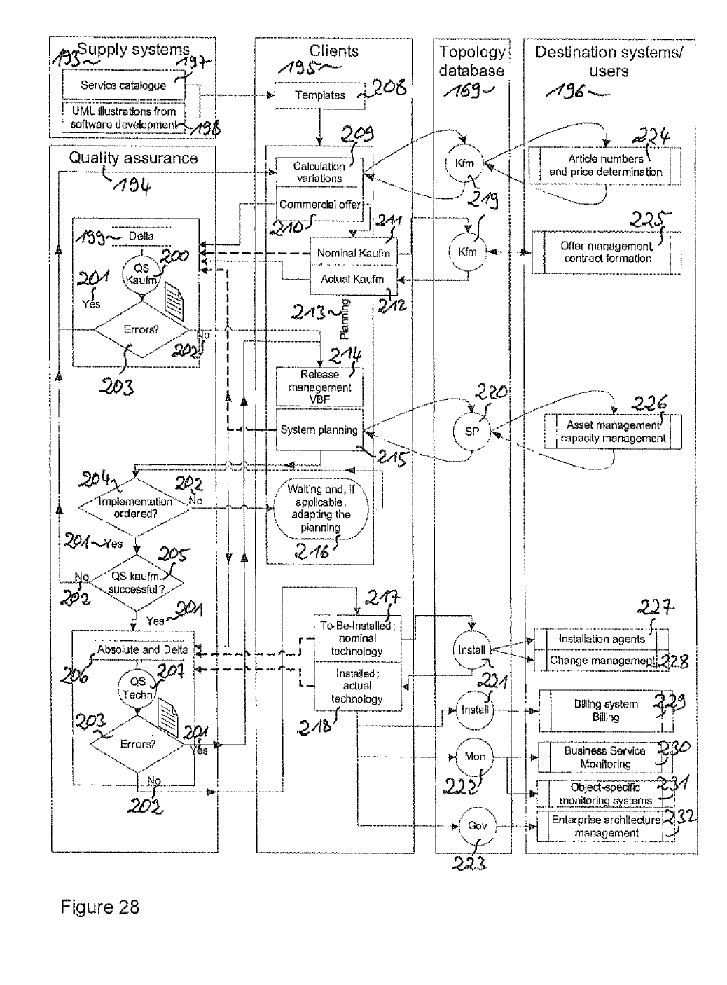

FIG. 28 shows how different tools interact in order to realize the overall handling of an IT process on the basis of the structure tree. The supply systems (193) and the elements of the quality assurance (194) are shown on the left side. The structure tree itself is maintained in different clients (195) that form the basis for the acquisition process and the installation process, respectively. The circular elements (219 to 223) respectively designate an analysis component of the structure tree. The rightmost illustration shows the respective destination systems or users (196) that process the information of the structure tree.

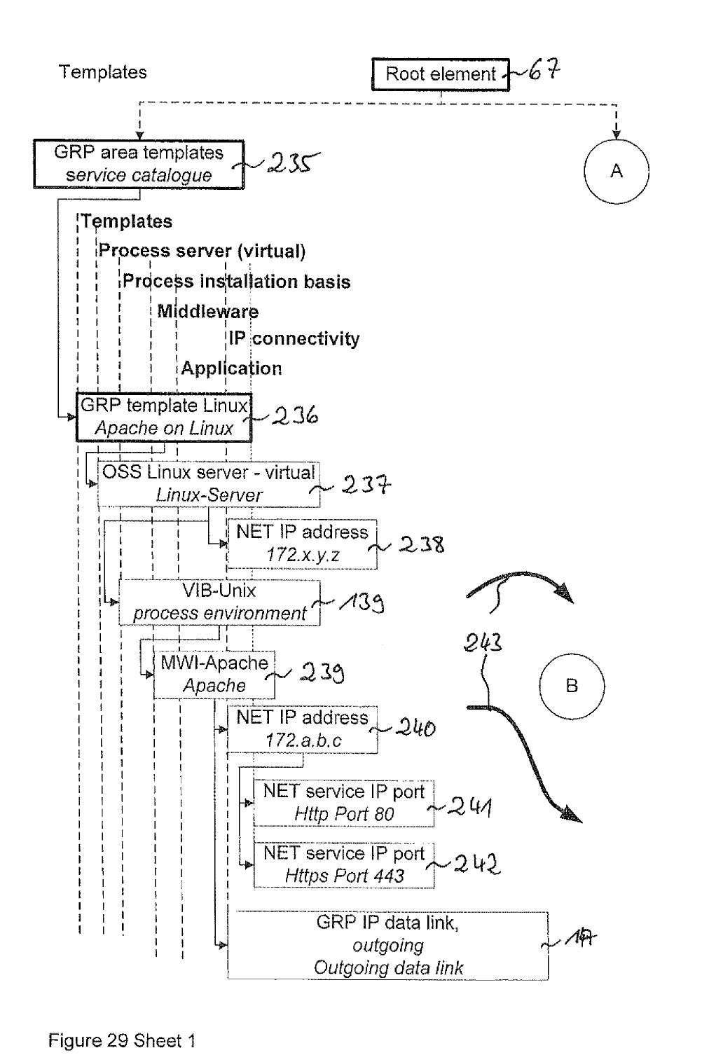

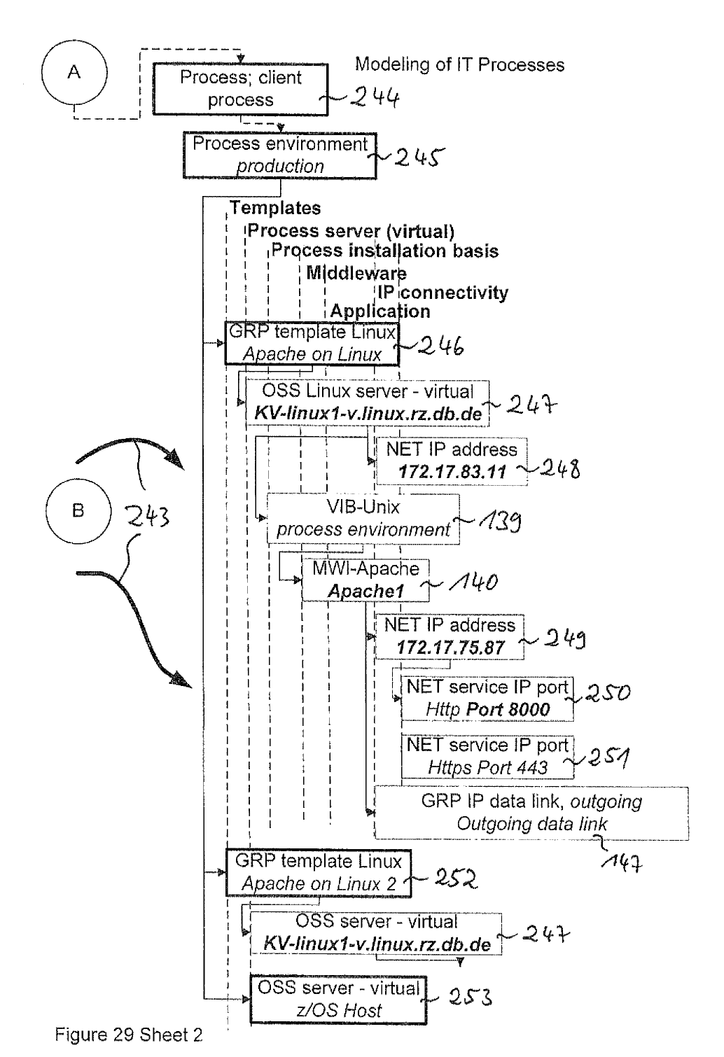

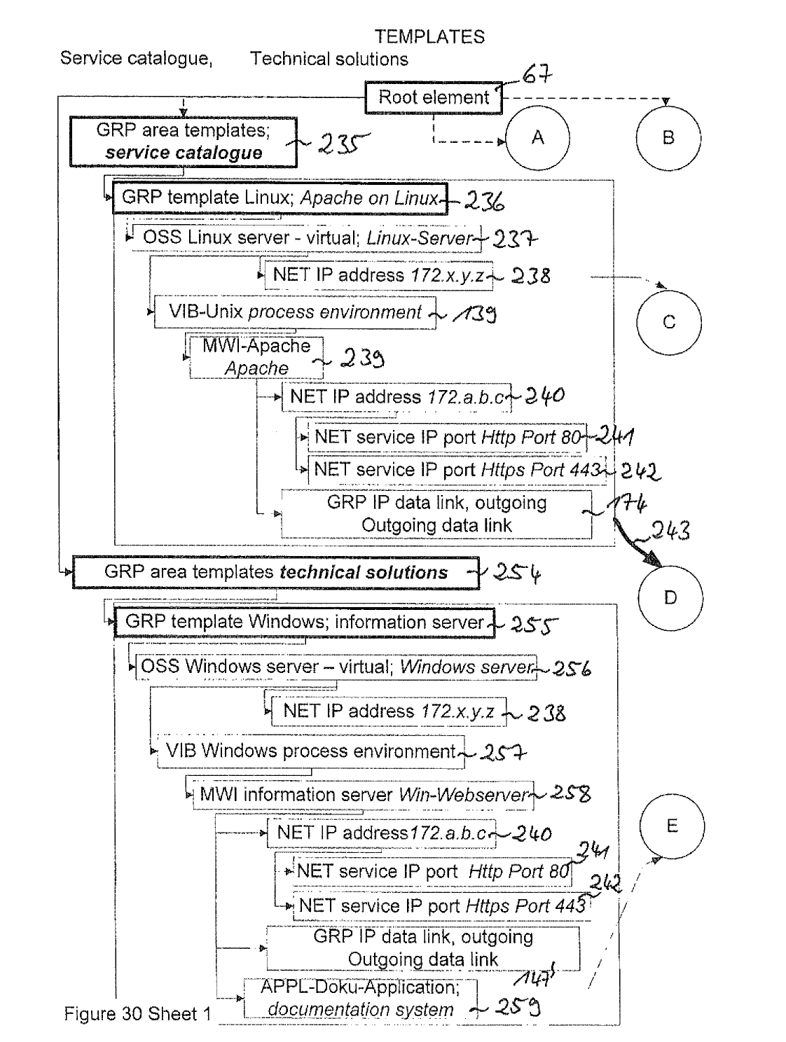

FIG. 29 shows in an exemplary fashion how a template for a technical IT process description may be laid out (left) and how it is used for modeling an IT process (right). The template for the presently used configuration of an Apache webserver on a Linux server (236 with corresponding child elements 237 to 242, 139, 147) comprises the basic illustrations of all elements required from the perspective of the IT process beginning with the Linux server (237) to the IT process installation basis (139) (file systems, groups, privileges) up to the middleware Apache (239) and all data-related connectivities (238, 240, 241, 242, 147). The attributes for the individual elements are, if possible and sensible, preset to certain values such as, e.g., the current version numbers of the Linux operating system and the Apache webserver. The template for each of the two Apache webservers (246, 252) can be utilized in the IT process to be modeled.

The template is respectively transferred into the IT process description under the IT process environment production (245) by means of the Smart Copy mechanism (243).

During this process, the predetermined structure is duplicated and the proper names and attributes of the elements are adapted.

During the copying process, a few of the default values are manually replaced, e.g., the IP address 172.a.b.c.d (240) from the basic illustration of the Apache server (239) in the template according to the Smart Copy process is replaced with 172.17.75.87 (249) in the description of Apache1 (140) in the IT process. Likewise, attributes can also be changed during the course of the copying process.

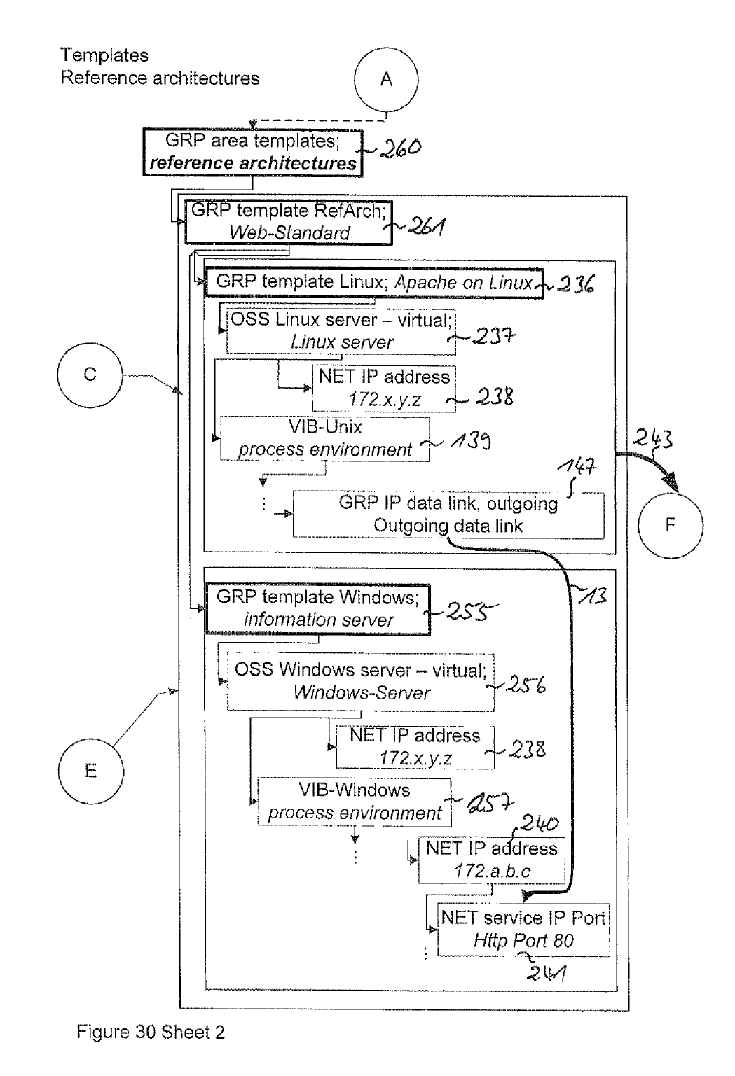

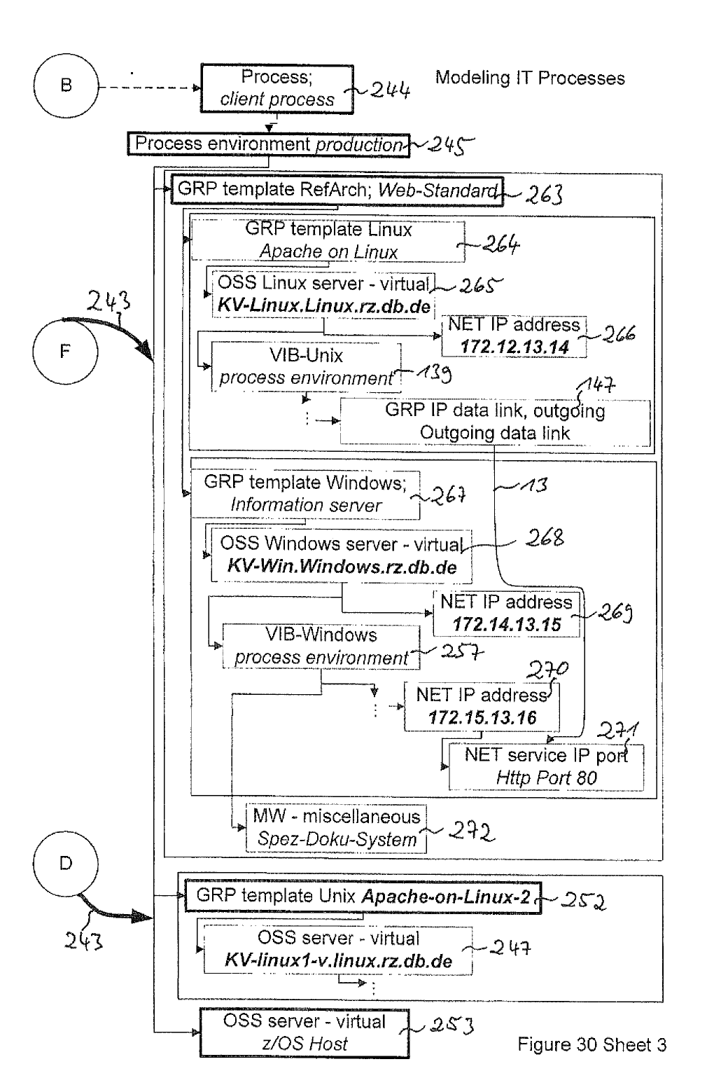

FIG. 30 shows how a reference architecture (260, with assigned child elements) utilizes service elements of a service catalog (235, with assigned child elements) and technical solutions (254, with assigned child elements) as description basis. The reference architecture (260, with assigned child elements) is then available for the modeling of an IT process description illustrated on the right in the form of an independent master template. The configuration of an Apache webserver on a Linux server known from FIG. 29 is illustrated on the upper left. A template from the area of technical solutions, in which an information server (258) is set up on an OSS Windows-Server (256), is illustrated on the lower left. A documentation system (259) and all data-related connectivities (240, 241, 242, 147) are set up on the information server (258).

The service elements of the service catalog for the Apache server on Linux (236 with corresponding child elements) are combined with the elements of the information server from the area of technical solutions (255 with corresponding child elements) in a reference architecture (261 with corresponding child elements).

In the modeling of the IT process illustrated on the right side, it is possible to utilize the reference architecture, as well as individual elements of the service catalog and the area of technical solutions, respectively. Any arbitrary combination of reference architectures, service elements of the service catalog, technical solutions and miscellaneous elements (e.g., 253 and 272) would generally be conceivable. In the modeling of the IT process illustrated on the right in FIG. 30, the above-described reference architecture (261, with corresponding child elements), as well as another Apache on Linux (Apache-on-Linux2, 252, with corresponding child elements) were inserted with the aid of the Smart Copy process (243); furthermore, an OSS server-virtual, a z/OS Host (253) and the Spez-Doku system (272) were set up as miscellaneous elements.

The invention is based on a suitable modeling of the IT process that makes it possible to illustrate and process all information relevant to the IT process in an automated fashion. This makes it necessary to self-consistently and distinctly model the information. It furthermore needs to be precluded that any loops can occur in the automatic processing of the information. The modeling is realized generically because it should already be available prior to the realization of the IT process. This furthermore provides the advantage that changes in the IT process topology can be taken into account without having to wait for the concrete realization of the elements.

The inventive method according to Claim 1 makes available a method for the generic creation of a structure tree for describing the topology of an IT process. In this case, the complete environment consisting of clients, servers, middleware components, applications and network components that an end user requires for carrying out a specific IT-supported business process is modeled. The elements of the meta-model correspond to the components of the IT process.

In the meta-model, a meta-element type is assigned to each of the elements used in the structure tree. The meta-model describes which element types are permissible. The element types include all common generic IT components such as server, middleware, storage, etc. It is furthermore defined which attributes for the element types are permitted and/or required and which relations are permitted between the elements with their corresponding attributes.

In order to already ensure during the modeling that no undesirable loop relations can occur among the elements, the formalism of the meta-structure only permits distinct and loop-free topological relations between the IT process elements. The elimination of loops is achieved in that an acyclically directed graph is used as meta-structure. An acyclically directed graph starts at a root element, under which all elements are organized in parent-child relations (4). In this case, child elements (2, 3) are subordinate to the respective parent elements (1). On the other hand, the child elements themselves may be parent elements (2) of other child elements (3), however, with the restriction that they cannot have any child elements that form part of their own parent elements (5, see FIG. 1). Undesirable loops cannot be created in the first place because child elements that on their part are already set up as their parent element are prevented from being assigned to a parent element during the setup of the elements due to the formalism of the meta-structure.

The inventive method furthermore ensures that a child element only has one respective relation with its parent element(s). Once a relation between parent element and child element exists, it is not possible to set up a second relation between the same elements.

This restriction prevents, for example, the same server from being added twice into a server cluster.

Due to the elimination of loops and the distinctiveness of the elements, the information contained in the IT process is structured such that an automated processing of the information can be realized.

Each of the elements contained in the structure tree can be concretized with attributes.

In this case, one advantageously distinguishes between 4 categories of attributes:
1. Attributes that are important for the context description during the course of the installation:
For example, if an operating system instance should be installed, it must be known which version of which operating system needs to be installed. When data links are established, the IP addresses and the addressed services need to be known.
2. Attributes that are important for the operational organization:
It must be known, e.g., with which service level the element is operated and who is responsible for the support in case of technical and functional defects.
3. Attributes for the billing of the service: services are rendered.
The purchaser and the contract conditions must be known. A few of these aspects are also relevant to the operation. It is therefore sensible to directly associate this information with Item 2.
4. Attributes for the technical fine-tuning of the components:
Suitable parameters for the fine-tuning of components are dependent on many and sometimes also functional parameters. This detailed information is irrelevant for the initial installation of an IT process. For example, a database for an IT process can be built up by means of simple commands such as CREATE TABLE, INSERT, . . . In this case, the 500 special parameters for the configuration of the database are irrelevant during the initial installation.

The information contained in a structure tree of an IT process is further processed for the overall handling of an IT process. The acquired structure tree can be utilized in many different ways. In this case, a cycling of similar steps that can be combined in special components is always carried out.

In this respect, one generally needs to distinguish between 4 steps:
1. IT process description (visualized in tree illustration or graphically in the form of a generically created architecture image)
2. Analysis of the structure tree as a preliminary stage for the data preparation for the destination systems
3. Data preparation and adaptation of the data to the respective interfaces of the destination systems
4. Utilization of the data by the destination systems.

FIG. 27 provides an overview of the destination systems.

The information of the structure tree (170) that is respectively contained in basic structures or templates already can be further processed during the acquisition of the information. The commercial destination systems (186, 187) utilize the information in the offer phase by means of a converter (179). The elements modeled in a structure tree are provided with article numbers and prices. The offer management can be controlled up to the contract formation.

The information from asset management and capacity management (180) is utilized during the system planning. This supports, for example, the assignment of servers or storage in IT processes. The asset management is the system management of an IT process. In this case, a distinct ID is assigned to each element. In addition, contact information of the customers, contract IDs and the like are also managed in asset management. Furthermore, asset management forms the basis of the capacity management, in which all existing resources and the respectively occupied and still available resources are managed in terms of quantity. The asset management utilizes information of the structure tree (170) on how many resources should be occupied.

During the course of the quality assurance, complex check routines (181) can access the prepared data (174) in order to carry out more complex checks that exceed the correlations established so far in the structure tree (170).

The information contained in the structure tree (170) is accessed for the installation of the IT process in order to determine, appropriately sequence (182) and suitably parameterize (175) the installation tasks.

The actual installation can be monitored by a workflow component (182). The individual installation tasks are either carried out automatically by means of suitable scripts (189) or tasks to be manually carried out by the responsible managers are specified in change management (190). The installation status is transmitted to the asset management (191) and the capacity management.

The application should also be monitored after it is installed. For this purpose, IT process-specific monitoring tasks contained in the tree could on the one hand be ordered in the individual monitoring systems (183). On the other hand, the structure tree can be mechanically reversed (184) as described in Claim 12 and then made available to the service-oriented monitoring system (192). In order to respectively set up and configure the monitoring systems, both tasks also require an interpretation of the information of the structure tree (170).

Furthermore, excerpts of the information contained in the structure tree (170) can be transferred to the Enterprise Architecture Management (185). The information supports the planning, for example, in that the currently used version numbers for all respective elements are known for each IT process/each environment or in that all technical data relations between different IT processes can be made available. This supports the reconciliation with functionally known data relations between the IT processes.

Claim 2 describes an advantageous embodiment of Claim 1. The distinctiveness of the name assignment to the elements of the generic meta-structure is controlled with the aid of unique elements and non-unique elements. The decision as to whether an element is unique or non-unique is made in the meta-model. Unique elements (6, 7) are elements, the proper name of which (that generally consists of the element type and the element name) occurs exactly once within the topology. Non-unique elements (8, 9), in contrast, are assigned their distinct name in the topology in that their proper name and the name of the superordinate parent element are combined into a comprehensive name during the generation of the element (see FIG. 2). The proper name of non-unique elements therefore does not have to be distinctly designated. Furthermore, only two types of relations between parent and child elements are permitted in the meta-structure. During the set-up of the elements, it is decided whether the parent-child relation is a primary relation (16) or a secondary relation (13). When a child element (15a, 15b) is newly incorporated into the meta-model of the IT process, it therefore needs to be assigned to at least one parent element (12) by means of a primary relation (16). The child element (15b) only can also be assigned to other parent elements (11) by means of secondary relations (13) if this is the case. This means that secondary relations can only be established with elements that are already set up in the meta-model (see FIG. 4). If a child element (15a) has no primary relation, it is therefore also not possible to assign a secondary relation (14) to this child element.

The comprehensive name for the non-unique elements of the platform group is formed with their proper name in association with the parent element by means of a primary relation that defines the name. Since the comprehensive name of the non-unique element needs to be distinct, non-unique elements can never have more than one primary relation to a parent element. According to the invention, the formalism of the meta-structure accordingly prevents the assignment of more than one primary relation to a non-unique child element.

When establishing a new secondary relation with an already existing element, a direct reference to the existing element is created.

The starting points and end points of all relations are defined based on the names of parent and child elements of the relation.

As an additional restriction in the meta-structure, either only one primary relation or one secondary relation is respectively permitted between two element types. The primary relation expresses that a child element can only exist on the basis of the parent element. The secondary relation, in contrast, expresses that the parent element utilizes an already existing child element. Creation and utilization in one are mutually exclusive. Consequently, this restriction creates a detailed linguistic and contentual definition that benefits the subsequent utilization of the structure tree for automation purposes.

Since attributes can be assigned to each element contained in the structure tree, it is possible to determine the properties of the elements that are relevant to the interaction of the elements.

This likewise applies to the relations contained in the structure tree, for which the properties of the relations that are relevant to the interaction of the elements can also be determined with the aid of attributes.

Claim 3 describes how data links are advantageously modeled in the meta-model. Data links describe a data exchange between sender and receiver, e.g., on the basis of an IP link. The sender can only send data to a receiver if the receiver exists and is ready to receive. The data link therefore is modeled in the form of a secondary relation (13) (see FIG. 6).

In a few instances, data links need to be rendered identifiable. This is realized by modeling the data link in the form of a separate model that has its own name (42, see FIG. 7).

Particularly in DNS links, several senders (43, 48) are combined in that several parent objects (36) are permitted for the designated data link (42) (see FIG. 8). In DNS-based “load balancing,” i.e., the load distribution over several destination systems by means of a distribution algorithm such as, e.g., round robin, in which transactions are in turn assigned to the destination systems, there exist several receivers (e.g., 60/50 or their parents 31, respectively) that can be addressed via a DNS link. The data link also is advantageously modeled as a separate element in the meta-model for this purpose.

Transparent services may, if applicable, influence the data or the data flow along the data link. For example, firewalls may make it impossible to reach certain destinations or load balancers may forward the data to different destinations in accordance with their own algorithms.

Such services may also consist of Net Address Translation (NAT) and port translation. The intrusion into a data link is advantageously modeled in the form of a child element (64, 66) of a designated data link (40) in the meta-model. In this way, it is possible, for example, to attach a firewall rule (64) to a designated data link in the form of a child element. In this case, it needs to be observed that only the filewall rule is attached as child. The firewall itself is modeled in the form of an IT component (63) because the technical component is managed via IP links (see FIG. 9).

It is also possible to describe other synchronous and asynchronous data links such as, e.g., fiber channel links, file transfers and message queues with the same methodology.

According to Claim 4, the structure trees can be structured in a clearly arranged and manageable fashion by setting up groupings of elements (see FIG. 10). For this purpose, grouping elements that may also have attributes can be modeled with the aid of unique elements, as well as non-unique elements.

A separate branch is created in the structure tree for each group illustration. Such substructures can also be used for modeling the IT process in various respects. The substructures can be associated with one another by means of primary and/or secondary relations. It would be possible, for example, to model groupings that assign the IT process (77) to a generic IT process group (76, e.g., all IT processes of a certain client). The IT process (77) in turn can be divided into individual releases (78, 79) and a platform group (88, also referred to as platform tree), in which the physical components are concretely illustrated. This allows an efficient and flexible illustration of the information on the development of the IT process over the course of the different releases (see FIG. 11).

Claim 5 describes how the information that is illustrated in FIG. 13 and required for the creation of the structure tree is advantageously acquired and utilized. Numerous different stations (roles, responsibility areas) from distribution to service management, release management, operational platform management, IT process management, etc., are involved in making available an IT process. The modeling of the inventive IT process takes into account all of these situations in order to provide a consistent and automatable basis for comprehensive management. In this case, the basic structure of the structure tree according to the preceding claims supports the entire process.

According to Claim 5, the process of acquiring the information required for a complete installation of the IT process cycles through the following steps:
1. It is advantageous to operate with templates (208) that serve as an acquisition aid, as well as for simplifying the association between the technical and the commercial description of an IT process. A service catalog (197) that describes the standardized service elements is particularly advantageous in this respect. The service catalog defines the service elements, describes these service elements in the sense of a product catalog, structurally describes these service elements in the sense of the structure tree as a template and specifies a price model for the service reference.
Another option for incorporating templates into the creation of a structure tree is available if the software is created with the aid of a standardized software modeling language during the course of the design of an IT application. This may be realized, for example, in the known modeling language UML (Unified Modeling Language). The information contained in the software modeling is used for creating the coarse structure of the structure tree. For example, a UML diagram (server components, 198) may be created during the course of the design of an application. This diagram type provides information on the basic structure of the IT process. The basic interconnections of the IT process and possibly also initial specifications with respect to the versions to be used such as, e.g., “at least version xx” of an operating system or a webserver, etc., are contained herein. This image also provides information as to whether or not certain software can be clustered.
Reference architectures and other technical solutions can also be used as master templates for the creation of a structure tree of an IT process. Technical solutions ultimately are identical to service elements of the service catalog with the exception that a universally valid price model does not yet exist in this case, but the prices rather are agreed upon individually. Consequently, there are no changes from the perspective of the technical IT process description and its templates. Reference architectures should ideally be composed of service elements of a service catalog or at least of technical solutions. The reference architecture therefore is offered as a template that normally comprises several service elements and technical solutions. However, it basically also provides the option of supplementing other elements outside the definition of the service catalog and the technical solutions.
2. During the course of the offer preparation (209, 210) for a customer, it is specified with which components and on which scale the service for the end customer is rendered. In this case, the cost-determining factors such as the number, the performance parameters and the type of the service elements to be used are defined, e.g., the number of CPUs to be used, the random-access memory, the disk space, the service level and the performance level. This may concern, for example, how many servers of which type (124, 126, 129), middleware instances, database instances and application instances should render the service at which price and under which conditions (e.g., service level, operating time, . . . ) on which environment types (125, 130 or 127, 131), operating systems, etc. In order to allow the complete automation of a subsequent provision process, it is in this case absolutely imperative that only services are offered that originate from a well structured, database-supported service catalog (197, 208) and therefore are machine-readable. It is therefore indispensable to utilize a structure defined under item 1) for the offer preparation. Any additional agreement that is stored in an arbitrary fashion and does not match the structure defined under Item 1) would no longer make it possible to automate the entire process.
The early, structured and complete documentation of the future environment assists in carrying out the order process without errors. The explicit documentation ensures that no service element to be planned is neglected. In addition, all service elements are described in such a complete fashion that they can subsequently be installed in an automated fashion. The description in this step is still isolated from the concrete destination environments that are subsequently specified by the operational platform management (88). From an operational perspective, the description is, however, already more concrete than the illustration from a possibly preceding software development because all redundancies and quantities are already exactly described in this case. This is illustrated in FIG. 23.
An offer with respect to the new environment is prepared for the end customer on the basis of the previously defined elements and quantitative information. Service level agreements that refer to the service modules in the service catalog are assigned to the individual order options. The contract formation takes place, if applicable, after several rectifications.
3. After the end customer has agreed to the offer and placed the corresponding order, the IT process is acquired in the commercial systems (225) on the one hand and the acquisition for the automated IT process installation (214) needs to be completed on the other hand. In this case, the acquisition of the IT process takes place inclusive of the specializations such as groupings, e.g., for the formation of installation groups and the setup of data links within the IT process and with other IT processes. The illustrated data links describe the “useful data traffic” of the application. Servers and miscellaneous IT process elements are described non-uniquely in this illustration because the correct description of an individual release has priority in this case.
4. Concrete platform instances such as, e.g., operating system instances, servers, message queue managers, etc., in the grouping of the platform tree are now assigned (215 with the support of 220, 226) to all IT process elements of the process tree that, based on their platform nature, are capable of supporting several identical IT process elements. Consequently, this primarily concerns service/operating system instances, middleware components and network components. The platform elements are set up by utilizing unique elements. The assignments are respectively realized in the form of secondary relations of the IT process element to the platform element, however, with the stipulation that an IT process element is assigned to exactly one platform element after all assignments have been completed. A few of the assignments of the IT process elements to the platform elements can be directly derived from other data sources. This may concern, for example, the assignment of a server to its network switch. The assignment can be realized in an automated fashion in these instances.

All concrete environmental conditions need to be taken account in the specification of the elements:
a. The physical locations to be used: in distributed environments, it needs to be ensured that the requirements with respect to the Business Continuity are met. Locations are chosen under the aspect of the data relations within and to/from outside the IT process and the availability of resources and network areas.
b. The network segments to be used and the special IP addresses for the IT process are defined. IP addresses for the IT process such as, e.g., alias addresses for webservers are independent of the IP addresses of the basic servers.
c. The host names of physical, logical and virtual servers are defined. If they do not yet exist, IP addresses for the normal data traffic, backup and system management are assigned to the servers.
d. The names of the middleware components and applications concretized in Step 2) are checked.
e. The middleware and application components receive platform-specific additional information such as, for example, the assignment of IP addresses and ports if this has not been carried out yet under Step 2). In addition, other specific information is acquired such as, e.g., the assignment of the queue to the corresponding queue manager in MQ.
f. Element-specific monitoring tasks that are particularly important for the monitoring of the IT process can be defined for the individual elements. If these tasks are well structured, they can be described with a high degree of standardization such that the object-specific monitoring tools can thusly be configured in an automated fashion.

The acquisition process requires the manual acquisition of information on the IT process at quite a few locations. In this case, the objective at hand consists of being able to quickly carry out these acquisitions in a largely error-free and also largely uncomplicated fashion. Claims 6 and 7 make available implements that support the acquisition process in this respect.

Errors in writing occasionally occur in the manual acquisition of free text. In order to avoid such errors, specifications for recurring expressions that restrict the input options of the user are defined by means of the meta-model according to Claim 6. Such specifications are referred to as Regular Expressions and may define, for example, how and IP address or a web address needs to be laid out, when uppercase letters and when lowercase letters need to be used, etc.

Another advantageous embodiment of the invention according to Claim 7 contributes to avoiding errors in the acquisition of information for the structure tree of the IT process.

Many values can be selected from tables. The Value-Source mechanism makes it possible to efficiently restrict the number of values (95) that can be selected from a large table by utilizing all information that was already acquired in the path above for restricting the target quantity (see FIGS. 14 (18)/(94) and (90)/(93) and (69)/(92)). Each reference to a comparative column of a selection table is formulated as one respective condition in the meta-model. The conditions are combined into an overall condition by means of an AND operation. In this case, the table with all entries would only offer the values (95) that fulfill the overall condition. In case a formulated condition cannot be applied to elements or attributes, for example, because the meta-element type of the condition was not used in the acquired tree, this condition is skipped and not applied. This means that the user receives a greater result set in this case.

When an attribute is acquired, the label of the corresponding element can also be taken into account in the selection.

It is furthermore conceivable to correspondingly access an API or a web service rather than accessing a data table with identical search terms. An API or a web service returns corresponding valid values in list form. This is advantageous, for example, in the dynamic determination of valid IP addresses of an element.

Claim 8 describes how to advantageously proceed if structured information on the IT process already exists and should be automatically transferred into the meta-model.

A few topologies or topology components of the IT process can be directly transferred from other data sources. The assignment of network components such as, for example, switches to servers is managed in an autarkic fashion in network management systems or the assignment of virtual systems to servers takes place in an autarkic fashion under the control of a separate management system. Thusly specified structures can be frequently exported from the management systems.

After a little formatting, these structures can be directly read into the meta-model via the bulk import (mass data import). In this case, the structure to be read in needs to refer to a distinct node element, under which the mass data structure must be read in.

The bulk import monitors that only permitted relations are imported. The import takes place in several stages.

Initially, the elements, attributes, primary relations and secondary relations are respectively set up or deleted. The relations and meta-types are then checked with respect to their validity. If it is determined during this check that at least one primary relation or at least one meta-type is not valid, the entire import process is aborted.

If it is determined during the check that secondary relations are no longer valid, an error list containing each invalid secondary relation is prepared. Invalid secondary relations need to be manually controlled because they are a reference to the fact that another element assumes the continued existence and validity of this relation that, however, no longer applies.

Such a bulk import can also be carried out online by means of a web service or a similar API without deviating from the scope of the invention.

Claim 9 describes how already acquired substructures of the structure tree can be duplicated and inserted at a different location of the structure tree. In IT processes, it is frequently necessary to acquire multiple structures that are nearly identical. These substructures only differ with respect to their server names, IP addresses or one to two attributes in most instances. Otherwise, these substructures are completely identical. An acquired structure can be easily duplicated by means of the Smart Copy/Smart Paste function and adapted during the course of the duplication such that the acquisition does not have to be repeatedly carried out in its entirety.

The proper names and the attributes of the elements can be changed during the adaptation.

Elements can neither be deleted nor added. All relations within the copied subtree are preserved.

Elements that are merely incorporated into the subtree by means of secondary relations cannot be edited because only a referencing relation exists to these elements.

Prior to the insertion of a copied subtree, all meta-model relations are checked with respect to their validity at the location, at which the copied subtree should be inserted into the meta-model. The copying process is not physically carried out until it is ensured that the subtree completely conforms to the meta-model. Optionally, relations of parent elements that lie outside the cut tree to the child elements of the copied subtree can be transferred (duplicated) to the newly set up child elements during the insertion. This may concern primary relations, as well as secondary relations.

Claim 10 describes how the prerequisites for converting the structure tree into the monitoring structure tree are advantageously created in the inventive meta-model. The end user perspective has priority in service-oriented monitoring and also in service-oriented reporting. The end user wants to utilize a business process. This business process is supported by one or more IT processes. These IT processes are based on the IT process-specific application software that is made available on middleware components and servers and utilizes diverse persistence layers such as, e.g., database instances.

The monitoring structure tree therefore is mirrored with respect to the installation structure tree underneath the IT process (FIG. 17, 77).

If no clusters would exist, a very simple mapping rule between the two trees would already have been established in this fashion. This simple instance is illustrated in FIG. 17. The structure tree of the process installation is illustrated on the left and the monitoring structure tree is illustrated on the right.

If clusters come into play, the complexity of the conversion of the structure tree into the monitoring service tree increases disproportionately. With respect to clusters, it is initially necessary to distinguish between three functionalities from the installation perspective:
a) The application software of the clustered element illustrated in FIG. 18 internally ensures a data reconciliation between the different technical application instances that externally represent themselves as one instance. This applies, e.g., to a Veritas cluster. Externally, the Veritas cluster makes available an operating system instance, e.g., Server-100c (104) that, however, is internally formed of two physical servers, e.g., Server-100n (107) and Server 200-n (108). For example, if the primary Server-100n (107) fails in this case, the secondary Server-200n takes over after a short transition period and makes available the operating system instance Server-100c (104). The servers may consist of logical as well as virtual servers. The servers already need to be set up before Veritas is installed. This is the reason why the association is realized by means of secondary relations (13).
b) The different instances are addressed by means of series-connected DNS-based load balancing (also referred to as global load balancing). The instances of this cluster (53, 58) are simultaneously active (see FIG. 19).
c) The different instances are addressed by means of series-connected active load balancing (also referred to as global load balancing). The instances of this cluster are simultaneously active.

All of these cluster types are illustrated identically in the monitoring. In this respect, the technical realization of the cluster is irrelevant from the perspective of an IT process. It is merely important that this cluster is made available and functioning properly.

A comparison of the three cluster types shows that all cluster variations are respectively initiated by a grouping element that is a child (if applicable, a grandchild) of the IT process environment (Veritas cluster (104), DNS data link (109) for global load balancing (110) and local load balancing (111 with 36)). Due to this mapping, the monitoring layer and also the graphic illustration of the architecture of the IT process can be automatically generated because the mapping is distinct.

In order to manage with a single structure tree for the IT process installation and the service monitoring, some additional information is required in the process tree. Viewed as a whole, the structure tree is the more detailed tree. This is the reason why the monitoring structure tree is derived from the process structure tree.

For service-oriented monitoring, clusters require threshold values, beginning at which the failure of a number of these cluster elements that is defined by the threshold value should be illustrated in a service-oriented monitoring process and, if applicable, evaluated is critical. The threshold values required for this purpose are assigned to the corresponding cluster group elements (Veritas cluster (104), DNS data link (109) and local load balancing (111)) in the form of an attribute; see FIG. 20.

For the object-specific monitoring of individual elements (117) (e.g., operating system instances, middleware or database instances, . . . , any monitorable object), it is possible to define in the structure tree the monitoring tool (118) and, if applicable, the monitoring tasks/scripts (119, 120, 121), by means of which these elements are monitored. This is illustrated in FIG. 21.

In a few special instances, it is practical to monitor one element with several different monitoring tools. This is the reason why the monitoring tool (118) is modeled as child element of the monitored element (117) in this case. The service-oriented monitoring can utilize this information for the classification of the events in order to illustrate the events in the respectively appropriate context. The individual elements “monitoring task x” (119, 120, 121) respectively comprise a machine-readable illustration of the monitoring task and the description of the corresponding handling instruction or the corresponding error recovery script, respectively. In this way, a Monitoring Event Database that is very helpful, in particular, for the IT process-specific monitoring processes is directly integrated into the structure tree.

Claim 11 describes how the generic structure trees can be adapted in order to also manage the company-wide architecture control. The correlations between the IT processes from the perspective of the business processes (12) are required as part of the company-wide architecture control. The business processes (102) are made available by one or more IT processes. Consequently, the existing technical dependencies between the IT processes and within the IT processes are relevant to the release planning from the perspective of a contractor. In this case, the structure tree for the IT process installation can provide significant contributions in two respects:
a. Since every synchronous and asynchronous data link is modeled, all technically realized relations between the IT processes can be immediately illustrated. This also applies to all data links with essential platform elements.
b. Elements can only be installed if exact version information exists. Important information for the company-wide architecture and license control is obtained by comparing this version information with the release plans of the manufacturers of the elements.

In addition, the structure tree can be advantageously supplemented for the automated IT process installation in such a way that the respective application components are assigned to the business processes (102) of the customer within the IT processes. This in turn may form the basis for setting up active end-to-end monitoring tools (123) or functional monitoring systems; see FIG. 22. Monitoring tasks and handling instructions or solution scripts (119, 120, 121) can be respectively assigned to the active end-to-end monitoring tools (123), as well as the functional monitoring systems.

Claim 12 describes a method, by means of which parts of the structure tree can be exported in a data format that supports the illustration of hierarchically structured data. Such a file format is created, e.g., with Extensible Markup Language (XML). Among other things, an automated installation of IT processes and the automatic configuration of management systems such as, e.g., of monitoring systems are possible due to the export of the service trees. These systems generally do not directly cooperate with the internal data structures of the structure tree description. With respect to the postprocessing in these systems, it is therefore possible to export subtrees in accordance with Claim 12. A pre-agreed Export Statement of a certain meta-element type (e.g., GRP environment 137) exports all elements that are set up in the subtree in the downward direction thereof up to the end point element, namely together with their corresponding relations.

In a few instances, however, the export that is strictly directed downward referred to the tree does not contain all information required for the installation of an IT process. This is the case, e.g., in the modeling of a data link. Starting with the “sender instance” (30), the export contains all information up to the destination port (in this case “80 http,” 39) in the example illustrated in FIG. 16. In the export that is strictly directed downward, however, the information as to which IP address (38) and to which receiver instance (37) this port belongs is missing.

In order to add this important information to the export, all relations in the upward direction of the tree are also exported for defined relations. From the perspective of the export, the tree therefore is mirrored at these locations and also exported. This additional upwardly directed export could, in principle, also be exported together with each element. For practical reasons and, in particular, to prevent the export from becoming unnecessarily large, however, it is proposed to only carried out this mirrored export when it is also definitively required. The definition as to when the export should also take place in the upward direction up to the Root Element (67) is indicated in the meta-relation to the relevant child element in the form of an attribute. In this definition, it can also be distinguished whether only primary or only secondary relations should be exported in the upward direction. It is furthermore possible to carry out export of structures in the above-described fashion online by means of an API/web service.

Claim 13 describes a method for planning and implementing an upgrade of an IT process by utilizing structure trees that are set up in accordance with the invention.

During the upgrade of an IT process, it is usually not sensible to completely remove the old release and then completely set up the new release once again. This is the reason why it is desirable to determine the differences between two planning stages of releases or the differences between two subtrees, respectively. According to claim 13, the comparison is realized in that the structure tree of the existing release is initially exported in a file format that supports the illustration of hierarchically structured data, e.g., in XML. This subtree is referred to as subtree A below. The structure tree of the planned release is then created and also exported in a file format that supports the illustration of hierarchically structured data. The structure tree of the planned release is referred to as subtree B below. Since the existing data is structured in uniform formats, it can be automatically compared, i.e., with the aid of a data processing system. The results of the comparison are also output in structured form, wherein one or more files are created (see FIG. 15).

It is therefore possible to quickly determine if an element with all its attributes is changed (96, 97) during the upgrade, which elements are depleted (99) during the upgrade, which relations are deleted (98) during the upgrade, which elements were supplemented (87) during the upgrade and which relations were added (100) during the upgrade.

It would furthermore be conceivable to also determine the differences between similar trees. In this case, trees are compared by renaming the root element of subtree A to the label of subtree B prior to the comparison. This leads to corresponding temporary name changes of the non-unique child elements and grandchildren of the root element of subtree A. These name changes can be detected and handled accordingly during the comparison such that information on the differences between two similar trees can be obtained in a comparable fashion with the aid of the inventive method.

It is furthermore possible to determine the differences between two planning stages of releases or the differences between two subtrees in the above-described fashion online by means of an API/web service.

According to Claim 14, a machine-readable storage medium such as, e.g., a CD-ROM, DVD, etc., is set up such that the data stored thereon can be read out by a machine in order to thusly cooperate with a programmable computer system in such a way that the computer system carries out at least one of the methods defined in Claims 1 to 13.

According to Claim 15, a computer program product with program code stored on a machine-readable medium is created. This computer program product can be executed on a computer such that at least one of the methods defined in Claims 1 to 13 is carried out on the computer.

The invention is described in greater detail below with reference to exemplary embodiments.

The user wants to utilize an IT process from his PC via the Internet. During the course of the offer preparation for a customer, it is now specified with which components and on which scale the desired service for the end client is rendered.

In this case, the components should originate from a well structured, database-supported service catalog such as, e.g., the product catalog of the provider of the IT operation for an IT process. The data of these templates should be machine-readable.

In the example, it is determined that the IT process requires a webserver and an application server.

The number of CPUs to be used, the random access memory, the disk space, the service level and the performance level need to be specified. If the configuration of an element cannot be distinctly described by means of a single object, the description is supplemented with other child elements of the object. For example, an operating system instance (18) may be reachable under several IP addresses (19, 21) or offer several IP services (20), (22) (see FIG. 5).

For example, an Apache webserver (140) should be used as webserver and a JBOSS-JEE application server (141) should be used as application server, wherein the webserver and the application server are linked to one another (148) in such a way that the Apache webserver can send data to the ajp-port (150, top) of the JBOSS-JEE application server. The software application (142) should run on the JBOSS-JEE application server 141 (see FIG. 24).

The OSS server KVA1-206v (138) is used as virtual IT process server that contains webservers and application servers.

The IT process should be installed in an automated fashion and integrated into the company-wide architecture control of the user. Furthermore, the reporting on the availability of the IT process and its elements, as well as a service-oriented monitoring and an incident management of the IT process, should be ensured without additional effort by the user. In addition, the provider wants to bill the services without additional administrative effort.

This makes it necessary to compile and manage the technical and commercial data of the IT process in a defined structure such that all processes relevant to the management of the IT process can draw upon one data source in an automated fashion.

For this purpose, all components of the IT process now are, according to the invention, modeled in a self-consistent, distinct and loop-free fashion.

All permissible element types are initially defined. These element types include all common generic IT components such as server, middleware, storage, etc. It is furthermore defined which attributes for the element types are permitted and/or required and which primary and secondary relations are permitted between the elements with their corresponding attributes.

The virtual OSS server belongs to the element type server, the webserver and the application server belong to the element type middleware and the software application belongs to the element type application. The attributes permitted or required for the respective element types serve for acquiring and managing the information that is relevant to the installation and support of the IT process. Furthermore, additional information may also be set up.

Based on this structured information, a structure tree for describing the topology of the IT process is now created, wherein this structure tree is based on a meta-structure in the form an acyclically directed graph. The structure tree starts at a root element. All elements of the IT process are now hierarchically arranged underneath the root element in parent-child relations.

Due to the formalism of the meta-structure, child elements that on their part are already set up as their parent element are prevented from being assigned to a parent element. Consequently, undesirable loops cannot be created in the first place (see FIG. 1).

It is advantageous to operate with templates that serve as an acquisition aid, as well as for simplifying the association between the technical and the commercial description of an IT process. The central element in this case is a service catalog that describes the standardized service elements.

The service catalog defines the service elements. In this example, the Apache server is a webserver of a certain design that is based on a Linux server (OSS process server) with defined file systems. In the service catalog, these service elements are literally described in the sense of a product catalog and structurally described in the sense of the structure tree in the form of a template. The service catalog furthermore contains a price model for the service reference.

In the template, the servers are pre-modeled from the service catalog on the basis of the Linux server. The virtual OSS process server (138) is the parent element of the IT process installation basis (139) due to a primary relation and therefore also forms the basis for its installability. The IT process installation basis (139) defines a file and privilege structure, into which the other IT process components (in this case the Apache webserver (140) and the JBOSS-JEE application server (141)) are installed.

The middleware components that run on the IT process installation basis are set up as its child elements by means of primary relations.

In order to provide a better overview, FIG. 29 only shows how a template for the configuration Apache-on-Linux is transferred into the modeling of an IT process. The template for the presently used configuration of an Apache webserver and a JBOSS-JEE application server on a Linux server (237) comprises all elements required from the perspective of the IT process beginning with the Linux server (237) to the IT process installation basis (file systems, groups, privileges) (139) up to the two middleware Apaches (239) and the JBOSS that is not illustrated in FIG. 29, as well as all data-related connectivities (240, 241, 242, 147, once again without JBOSS components). The attributes for the individual elements are, if possible and sensible, preset to certain values such as, e.g., the current version numbers of the Linux operating system and the middleware servers.

The template is then transferred into the IT process description (right in FIG. 29) by means of the Smart Copy mechanism (243).

During this process, the specific structure is duplicated and the proper names and attributes of the elements are adapted. Elements can neither be deleted nor added during the course of the Smart Copy process (243). All relations within the copied subtree are preserved. Elements that are merely incorporated into the template structure by means of secondary relations cannot be edited because only a referencing relation exists with these elements.

Prior to the insertion of a copied subtree into the structure tree of the IT process to be created, all meta-model relations are checked with respect to their validity at the location, at which the copied subtree should be inserted into the meta-model. The copying process is not physically carried out until it is ensured that the subtree completely conforms to the meta-model.

In the example, the template “Apache-and-JBOSS-on-a-Linux-server” is used once within the IT process description. This results in the structure tree shown in FIG. 24. During the copying process, a few of the specified values are manually replaced, e.g., the IP address 172.x.y.z of the Apache server is replaced with 172.17.75.87 (144). Likewise, attributes can also be changed during the course of the copying process.

It is important that valid rules of the meta-model are not circumvented when master templates are utilized. In the example illustrated in FIG. 29, for example, “GRP template Linux; Apache-on-Linux” (236) was defined as meta-element type for the master template. The first child of this master template is the meta-element type “OSS Linux server-virtual” (237). It needs to be ensured by means of the meta-model that the meta-element type of the master template (in this case “GRP template Linux; Apache-on-Linux” (236)) can only be used at locations, at which the meta-element type “OSS Linux server-virtual” (237) is also used. It is therefore not possible to define a general element type “template” that incorporates all element types as first child. Otherwise, this would make it possible, e.g., to directly link a middleware component (140) to an IT process environment (245) without server (247), wherein this would be technically inexecutable due to the missing operating system. In order to define the master templates, separate meta-elements (in this case, e.g., “GRP template Linux; Apache-on-Linux” (236)) therefore are respectively required for each child element type that initiates a template (in this case, e.g., the Linux server-virtual (237)). However, a separate meta-element is not required for each service element of the service catalog. Consequently, it is easily possible, for example, to build up all templates that are permitted on the basis of a Linux server such as, e.g., Apache-on-Linux (236), JBOSS-on-Linux, Apache-and-JBOSS-on-a-Linux-server, Apache-and-Linux-on-two-separate-Linux-servers, etc., on the basis of the meta-element type “GRP template Linux.”

After the insertion of the template Apache-and-JBOSS-on-a-Linux-server in the example illustrated in FIG. 24, the application KVA1-JEE (142) installed on the JBOSS server is set up as a child element of the JBOSS server (141).

In this example, it would also be conceivable to utilize a template in the form of a UML diagram that is developed during the course of the development of a new application for the IT process.

The application to be developed is then modeled in the modeling language UML. From this model, a UML diagram is created that already contains information on the basic structure of the IT process. This UML diagram (198) is converted such that it can be used as template (208) for the inventive IT process description. This template contains information on which element types are used in the IT process and how they are linked with one another by means of installation requirements and data links.

In this example, the structure tree illustrated in FIG. 24 results underneath the root element “root.”

The superordinate GRP elements (135-137) of the IT process description are initially set up on the left side. They serve for structuring the IT process of the customer A. The presently observed IT process is specified in greater detail by means of the subordinate elements customer process A1 (136). The GRP environment production (137) is assigned to said customer process. This is followed by the aforementioned IT process servers.

On the right side, the IT platforms that can be utilized by the IT processes are listed under the superordinate element GRP area RZ production (152). The physical components are assigned to the virtual components of the IT process description with the aid of secondary relations (13).

Some of the attributes and additional information on the elements are discussed below.

In order to correctly install an operating system instance (i.e., a virtual server) in a data processing center, information on the required performance class (CPU power, random access memory, . . . ), as well as safety-relevant information (e.g., installation site/fire zone, . . . ), is required. This information then also needs to be taken into account in the assignment to a physical server, as well as the assignment of the IP addresses. The virtual OSS server therefore needs to be described by these attributes.

The IT process installation basis (139) defines a file and privilege structure, into which the other IT process components (in this case, the Apache webserver (140) and the JBOSS-JEE application server (141)) are installed. Typical attributes for this IT process installation basis are:
user name and user ID
group name and group ID
path and file size
backup specifications
security zone
installation sequence (zero=default; positive value=first, second, third; negative value=last, next to last, . . . ).

Special parameters such as, e.g., the version number of the middleware and, if applicable, the version number of a component directly connected thereto such as the basic Java virtual machine, information on the starting behavior and on the backup or information on the service level of the middleware component are required for the various middleware components, e.g., the Apache webserver (140) or the JBOSS-JEE application server (141).

A significant amount of detailed information such as, e.g., the standard file systems of these middleware components do not have to be modeled. Everything that implicitly results should not be included in the modeling. Priority should always be given to the fact that the modeling should only include what also must be mandatorily modifiable from the perspective of the IT process.

Special information also exists on the applications (142), e.g., the version, the application or path information for locating the application.

It must be clear in which network segment and which VPN the IP address is required when the IP address is requested, as well as for subsequent decisions (e.g., for firewall rules). In addition, several network adapters are frequently available on the server side. In this respect, it would be desirable to specify, if applicable, via which of these interfaces the IP address should be routed.

In IP services, it must be clearly defined which IP service (name, e.g., http, https, ajp, . . . ) is assigned to which port or port range and whether the ports are set up for UDP or TCP.

Once the structure tree of the IT process has been created, it is, according to FIG. 28, transferred to the commercial analysis method (Kfm, 219) that determines (224) the required article numbers of the service catalog (197) from this information and prepares initial price information for the customer with these article numbers. The commercial handling also could already be realized when all technical details are not yet known. For example, it is irrelevant for the commercial handling whether the IP address 172.12.13.14 is assigned because it may suffice to know that an IP address is requested at all and even this information is possibly obsolete from a commercial perspective.

Once the interest of the purchaser of the IT process has been aroused, a concrete offer (210) is once again requested with the aid of the commercial analysis method (Kfm, 219) and a contract is formed and deposited (225). Since an offer is legally binding, the IT process description is transferred into the client “nominal commercial” (211), in which no changes can be made during the preparation of an offer, prior to the request for the offer. This status is transferred into the client “actual commercial” (212) with the contract formation. The offer may either be requested for the complete IT process environment or only to the extent of the required changes (199) (determined by comparing “nominal commercial” and “actual commercial”).

If the analysis method “QS commercial” (200) determines that the offer does not contain any errors and the order for the implementation is cleared by the distribution department, the IT process is planned in detail in client planning (213) by the release management (214) and system planning (215). The analysis method “QS commercial” (200) checks if it was possible to determine valid article numbers and if more complex dependencies are fulfilled (e.g., if element A is ordered with high service level, B must also be ordered with high service level). The method also provides references in the sense of warnings if serious differences exist between the old contract and the new future contract, e.g., price increases in excess of 10%. The system planning (and, if applicable, also the release management) is supported by the analysis method “system planning” (220). When ordering/agreeing upon an IP address, for example, structural information is evaluated such as, e.g., if the IP address belongs to a server in the production environment or the acceptance environment, in which security zone the IP address is required and which middleware should be made available on the server. One proceeds analogously in the assignment of storage. The analysis method “system planning” (220) supports, in particular, the capacity management (226). After planning has been completed, the thoroughly planned IT process description is initially subjected to quality assurance.

During the course of the commercial quality assurance (200), it is initially checked if any deviations (199) exist between the planned state and the state “commercial nominal” or “commercial actual” (depending on whether the workflows in the commercial systems are already completed or still in progress). No deviations can be detected in this case. If deviations occur, it needs to be ensured that the commercial systems are rapidly reconciled with the planned state, but only if the planned state meets all functional (commercial and technical) requirements. Subsequently, the technical quality assurance (207) takes place. From a technical perspective, various checks are carried out during this quality assurance, e.g., whether the assigned IP address meets the requirements of the server. This check is required because it cannot be precluded that the decision criteria for the assignment of exactly this IP address were changed after all due to the subsequent change of an attribute. If this is the case, the planning needs to be changed accordingly before the application can be installed.

The planning phase is now completed. The installation can begin as soon as the start signal is received from the distribution department.

Once all quality assurance measures were successfully carried out, the planned state is transferred into the client “to-be-installed” (217), in which it can no longer be changed. The QA ultimately confirms the correctness of the planning. The installation subsequently begins. The analysis method “install” (221) determines the installation tasks and causes these installation tasks to be carried out. This is either realized in an automated fashion by means of suitable installation scripts (227) or by creating change orders for the change management (228). All these tasks are carried out under the control of “install” (221).

After the completion of all installation orders, “install” (221) signals the implementation to the billing systems (229) such that the customer of the IT process can now also be billed.

The analysis method “Mon” (222) updates the monitoring orders for the object-specific monitoring systems (231) of the platform (Unix monitoring, webserver monitoring, application monitoring, etc.), as well as for the central Business Service Monitoring (230), in which the alarm messages of the different object-specific monitoring systems are correlated with one another.

The analysis method “Gov” (223) transfers information from the installed client (218) into the Enterprise Architecture Management (232). This concerns information, e.g., on the components used and their versions and information on the technical data relations in the IT processes.

In a second example, a given IT process is expanded with a separate database server (160) and with a client (159). This is illustrated in FIG. 25. The terminals are not individually modeled. In order to make it possible to create firewall rules in an automated fashion, however, the groups of terminals need to be illustrated in the IT process. In this case, a client that accesses the IT process via the Internet is illustrated in an exemplary fashion. This client (type OSS terminal group) receives the information on which VPN it accesses in the form of attributes. The database is initially modeled exactly like any other middleware component. In this case, a virtual server (160) is modeled, on which an IT process installation basis (139) for the database (161) is set up (i.e., file systems, groups and privileges). The database (161) is then set up on this IT process installation basis.

The database receives additional information that is important for the installation of the database such as, e.g., the database version, the character-set, the SID, information on the sizes of the required file systems and on the backup methods in the form of attributes. Patches or software options to be additionally applied can be described by means of other child elements of the database instance. The set-up of table spaces can also be described in this fashion.

Database clusters such as, e.g., Oracle-Dataguard are described in that they are inserted as parent element above the Oracle instances.

In the next example, a given IT process is expanded with a branch that is addressed by means of a global load balancer. FIG. 26 shows how two different client groups (159, 165) utilize the DNS service (233) in order to address a farm of webservers. The clients address the DNS address www.kva1.com. The DNS service resolves this address and alternately outputs the IP addresses and ports of the two webservers (i.e., 172.17.75.87 (234) or 172.17.75.88 (166) with port 80) as the destination address. The sequence, in which replies to the inquiries are realized with one or the other address, results from the chosen load balancing method. The load balancing method is usually round-robin. The load balancing method is indicated in the form of an attribute in the DNS address.

The DNS address (www.kva1.com) is the responsibility of the IT process manager. It forms part of the respective IT process context it is distinct for the respective DNS services. This DNS address therefore is uniquely modeled. It is the primary child of the IT process environment (137). This DNS address is utilized in that it is defined as secondary child of one or more outgoing data links (147) and in turn receives the destination ports (146) in the form of a secondary child.

In another example, the utilization of unique and non-unique elements is elucidated:

An Apache (82) is installed on a server (80) used in Release 1 (78) and Release 2 (79). Another Apache (Apache2, 81) is now installed on this server (80) in Release 2 (79).

If the server would be uniquely modeled, the tree could only express that Apache2 (81) is only valid in Release 2 (79) (see FIG. 11) with the aid of additional attributes or associations.

If the server is non-uniquely modeled, it is already possible to express that Apache1 (85) is relevant in Release 1 (78) and Apache1 (85) and Apache2 (87) are relevant in Release 2 (79) by means of the structure tree. In this variation, the server (83 or 84) is provided with its name (not the label) with reference to the parent element Release. However, the information as to the fact that the servers (83 and 84) are identical in Release 1 (78) and Release 2 (79) is lost in this illustration. The label is identical, but not the name.

In order to still be able to directly express in the structure tree that both Apache1 and Apache2 run on the physically identical server in both releases, the server is modeled twice: in the so-called process tree (on the left in FIG. 12 underneath the process group (76)), it is non-uniquely modeled (83 or 84). In the platform tree (on the right in FIG. 12 underneath the platform group (88)), it is uniquely modeled (89). The association between these server descriptions is respectively established by means of a secondary relation (13); see FIG. 12. In this combined solution, the platform tree is directly made available by means of import mechanisms. The acquisition of the process tree and the association with the elements in the structure tree is realized manually as part of the order for the take-over of the management.

Another example describes how the information of the structure tree can be used for the automated IT process installation.

For the automated installation, for example, all information is exported in a suitable format such as, e.g., in XML (or made available in an API) and transferred to an automatic installer. Based on the tree, the automatic installer determines the complete installation parameters for each element and specifies the installation sequence of the elements. The automatic installer finds the installation parameters for each element in the attributes of the IT process elements, as well as in the attributes of its parent and child elements, and possibly also in the attributes of the parent or child elements of one of its child elements. Element-specific configurations and tuning parameters can be accessed with references to other data sources. If applicable, the differences between the existing and the future release status of the IT process environment are also determined in this step such that only the changes need to be installed.

During the determination of the installation tasks (175), it is ascertained, e.g., that a Linux server, an Apache webserver, an application server and a database should be installed. In this example, the algorithm determines that the database was already suitably installed in a previous release such that this installation task can be skipped. The sequence of the tasks sequentializes the installation tasks and arranges them in suitable succession. Accordingly, the basic Linux server is initially installed before the Apache webserver is installed. A respectively suitable parameter set needs to be transferred to the installation scripts in order to also carry out the installation tasks. This parameter set is also determined based on the tree. The actual installation is monitored by a workflow component. The individual installation tasks are either carried out by means of suitable scripts or tasks to be manually carried out by the responsible managers are specified in the change management. The installation status is transmitted to the asset management and the capacity management.

Excerpts of the information acquired in the structure tree finally can also be transferred to the Enterprise Architecture Management (178). This information supports the planning, for example, in that the currently used version numbers for all respective elements of each IT process/each environment are known or in that all technical data relations between different IT processes can be made available. This supports the reconciliation with functionally known data relations between the IT processes.

During the course of the installation process, but no later than at its end, information on the provision of the IT process and the commencement of service is returned to the financial management (229). This means that the billing of the services can begin.

In conclusion, the utilization of templates for the modeling of frequently used IT process components is briefly described in greater detail with reference to FIGS. 29 and 30.

FIG. 29 shows in an exemplary fashion how a template for a technical IT process description may be laid out (left) and how it is used for modeling an IT process (right). The template for the presently used configuration of an Apache webserver on a Linux server (236 with corresponding child elements 237 to 242, 139, 147) comprises the basic illustrations of all elements required from the perspective of the IT process beginning with the Linux server (237) to the IT process installation basis (139) (file systems, groups, privileges) up to the middleware Apache (239) and all data-related connectivities (238, 240, 241, 242, 147). The attributes for the individual elements are, if possible and sensible, preset to certain values such as, e.g., the current version numbers of the Linux operating system and the Apache webserver, The template for each of the two Apache webservers (246, 252) can be utilized in the IT process to be modeled.

The template is respectively transferred into the IT process description under the IT process environment production (245) by means of the Smart Copy mechanism (243).

During this process, the predetermined structure is duplicated and the proper names and attributes of the elements are adapted.

During the copying process, a few of the default values are manually replaced, e.g., the IP address 172.a.b.c.d (240) from the basic illustration of the Apache server (239) in the template is replaced with 172.17.75.87 (249) in the description of Apache1 (140) in the IT process in accordance with the Smartcopy process. Likewise, attributes can also be changed during the course of the copying process.

FIG. 30 shows how a reference architecture (260, with assigned child elements) utilizes service elements of a service catalog (235, with assigned child elements) and technical solutions (254, with assigned child elements) as description basis. The reference architecture (260, with assigned child elements) is then available for the modeling of an IT process description illustrated on the right in the form of an independent master template. The configuration of an Apache webserver on a Linux server known from FIG. 29 is illustrated on the upper left. A template from the area of technical solutions, in which an information server (258) is set up on an OSS Windows-Server (256), is illustrated on the lower left. A documentation system (259) and all data-related connectivities (240, 241, 242, 147) are set up in the form of an application on the information server (258).

The service elements of the service catalog for the Apache server on Linux (236 with corresponding child elements) are combined with the elements of the information server from the area of technical solutions (255 with corresponding child elements) in a reference architecture (261 with corresponding child elements).

In the modeling of the IT process illustrated on the right side, it is possible to utilize the reference architecture, as well as other individual elements of the service catalog and the area of technical solutions, respectively. Any arbitrary combination of reference architectures, service elements of the service catalog, technical solutions and miscellaneous elements (e.g., 253 and 272) would generally be conceivable. In the modeling of the IT process illustrated on the right side in FIG. 30, the above-described reference architecture (261, with corresponding child elements), as well as another Apache on Linux (Apache-on-Linux2, 252, with corresponding child elements) were inserted with the aid of the Smart Copy process (243); furthermore, an OSS server-virtual, a z/OS Host (253) and the Spez-Doku system (272) were set up as miscellaneous elements.

### LIST OF REFERENCE SYMBOLS

1. Parent element
2. Child element 1
3. Child element 2
4. Permissible parent-child relations
5. Impermissible parent-child relation
6. Unique element, label=ElementB, name=ElementB
7. Unique element, label=ElementA, name=ElementA
8. Non-unique element, label=ElementC, name=ElementB ElementC
9. Non-unique element, label=ElementD, name=ElementB_ElementC_ElementD
10. Reference
11. Element type U, label=ElementA
12. Element type V, label=ElementB
13. Permissible secondary relation
14. Impermissible secondary relation
15. a) Element type W, label=ElementE
15. b) Element type W, label=ElementD
16. Primary relation
17. IT process
18. Operating system instance (BI)
19. IP address BI
20. IP port BI
21. IP address BI backup
22. IP port BI backup
23. Middleware Apache server (AS)
24. IP address AS
25. IP port 1 AS
26. IP port 2 AS
27. Middleware JBOSS-application server (JBOSS)
28. IP address JBOSS
29. IP port JBOSS
30. Sender instance
31. Data receiver grouping
32. IP address 1
33. IP port 1
34. IP address 2
35. IP port 2
36. Data sender grouping
37. Receiver instance
38. IP address 3
39. IP port 3
40. IP address 4
41. IP port 4
42. Known data link
43. Sender instance 1
44. IP address 1 sender instance 1
45. IP port 1_sender instance 1
46. IP address 2 sender instance 1_{—}
47. IP port 2 sender instance 1
48. Sender instance 2
49. IP address 1 sender instance 2
50. IP port 1 sender instance 2
51. IP address 2_sender instance 2
52. IP port 2 sender instance 2
53. Receiver instance 1
54. IP address_1 receiver instance 1
55. IP port 1 receiver instance_1
56. IP address 2 receiver instance 1
57. IP port 2 receiver instance 1
58. Receiver instance 2
59. IP address 1 receiver instance 2
60. IP port_1 receiver instance 2
61. IP address_2 receiver instance 2
62. IP port 2 receiver instance 2
63. Physical firewall
64. Data service firewall rule
65. DNS-based load balancer
66. Data service DNS-based load balancing rule
67. Root element
68. IT process group 1
69. IT process 1
70. Release 1.1
71. Release 1.2
72. Installation branch A
73. Installation branch B
74. IT process group 2
75. IT process 2
76. IT process group
77. IT process, label: IT process, name: IT process
78. Release 1, label: Release1, name: IT process_Release1
79. Release 2, label: Release2, name: IT process_Release2
80. Operating system instance, label: Server1, name: Server1
81. Middleware instance Apache Webserver 2, label: Apache2, name: Server1_Apache2
82. Middleware instance Apache Webserver 1, label: Apache1, name: Server1_Apache1
83. Operating system instance, label: Server1, name: IT process_Release1_Server1
84. Operating system instance, label: Server1, name: IT process_Release2_Server1
85. Middleware instance Apache Webserver 1, label: Apache1, name: IT process_Release1_Server1_Apache1
86. Middleware instance Apache Webserver 1, label: Apache1, name: IT process_Release2_Server1_Apache1
87. Middleware instance Apache Webserver 2, label: Apache2, name: IT process_Release2_Server1_Apache2
88. Platform group
89. Unique element physical operating system instance X, label: Prod_Server_X, name: Prod_Server_X
90. Release 1.1 with attribute: environment
91. New Middleware element to be detected
92. Comparative values 3 (IT process, 1 IT process 1, IT process 1, IT process 1)
93. Comparative values 2 (environment Prod, environment Prod, environment Test, environment Prod,)
94. Comparative values 1 (Server 1, Server 1, Server 1, Server 2,)
95. Result column (Middleware—MW-1, Middleware—MW-2, Middleware—MW-3, Middleware—MW-4)
96. Operating system instance with attribute: type=Solaris 9
97. Operating system instance with attribute: type=Solaris 10
98. Relation is deleted in Release 2
99. Group INet, deleted in Release 2
100. Relation is added in Release 2
101. Application instance
102. Business process
103. IT process environment
104. Veritas cluster operating system instance, Server100c
105. IT processs installation basis
106. Middleware
107. Server 1 (Server 100n)
108. Server 2 (Server 200n)
109. DNS data link
110. Global load balancing group
111. Local load balancer
112. IP address
113. IP port
114. Cluster
115. Cluster basis 1
116. Cluster basis 2
117. Element to be monitored, e.g., a Webserver instance
118. Monitoring tool, e.g., Nagios
119. Monitoring task 1
120. Monitoring task 2
121. Monitoring task 3
122. Server
123. End-to-end monitoring tool
124. Plan server 1 (#CPU, memory #GB, service level, . . . )
125. Middleware 1
126. Plan server 2 (#CPU, memory #GB, service level, . . . )
127. Application A
128. Business process G1
129. Plan server 3 (#CPU, memory #GB, service level, . . . )
130. Middleware 2
131. Application B
132. Business process G2
133. Physical server 1
134. Physical server 2
135. GRP area, client A IT process
136. GRP IT process, client process A1
137. GRP environment production
138. OSS-server—virtual, KVA 1-206 v.linux.rz.db.de
139. Process installation basis Unix, process environment
140. Middleware instance Apache, Apache 1
141. Middleware instance JBOSS, JBOSS 1
142. ApI-Application, KVA 1-JEE-Appl 1
143. NET IP address of server, 172.17.75.86
144. NET IP address of Apache Webserver, 172.17.75.87
145. IP link originating from browser of a client
146. NET service IP port, http; offered by Apache
147. GRP IP data link, outgoing
148. IP link from Apache to Weblogic, secondary relation
149. GRP default IP address server
150. NET services, offered by JBOSS server
151. IP link to a database
152. GRP area RZ production
153. GRP IT platform Unix server
154. OSS server, physical, RZ1-4711.linux.rz.db.de
155. NET IP address 192.168.1.186
156. NET service IP port ssh
157. NET IP address 192.170.1.186
158. NET service IP port backup
159. OSS terminal group, Internet client
160. OSS server virtual, DB-246v.linux.rz.db.de
161. DAT Oracle; Oracle-DB-KVA1
162. NET IP address, 172.25.36.11
163. OSS server, physical, RZ1-4712.linux.rz.db.de
164. NET service IP port sql
165. OSS terminal group, Extranet client
166. OSS server virtual; KVA1207v.linux.rz.db.de
167. NET IP address 172.17.75.88
168. Graphic front end
169. Topology database
170. Structure tree illustration
171. Structure tree analysis
172. Analysis rules: offer definition
173. Analysis rules: asset definition
174. Analysis rules: quality assurance
175. Analysis rules: determining, sequencing and parameterizing of the installation tasks
176. Analysis rules: object-specific monitoring
177. Analysis rules: service-oriented monitoring
178. Analysis rules: IT governance
179. Converter; determination of article numbers
180. Asset management, capacity management
181. Complex check routines
182. Workflow schedule
183. Object-specific monitoring tools
184. Converter; structure tree inversion
185. Enterprise architecture planning
186. Price information
187. Offer preparation; service level agreement
188. Responsible professionals; complex check routines
189. Installation script executor; for each element type
190. Change management
191. Asset management
192. Business service monitoring
193. Supply systems
194. Quality assurance
195. Clients
196. Destination systems/users
197. Service catalogue
198. UML illustrations from software development
199. Detection of differences between nominal-Kaufm and actual-Kaufm
200. Commercial quality assurance QS Kaufm
201. Yes branch
202. No branch
203. Branching inquiry: errors present?
204. Branching inquiry: implementation ordered?
205. Branching inquiry: QS Kaufm successful?
206. Detection of absolute values and differences between nominal technology and actual technology
207. Technical quality assurance
208. Templates
209. Calculation variations
210. Commercial offer
211. Nominal Kaufm.
212. Actual Kaufm
213. Planning
214. Release management VBF
215. System planning
216. Waiting and, if applicable, adapting the planning
217. To-Be-Installed; nominal technology
218. Installed; actual technology
219. Commercial analysis method, Kfm
220. Analysis method system planning, SP
221. Analysis method installation, Install
222. Analysis method monitoring, Mon
223. Analysis method IT governance, Gov
224. Article numbers and price determination
225. Offer management, contract formation
226. Asset management, capacity management
227. Installation agents
228. Change management
229. Billing system, Billing
230. Business service monitoring
231. Object-specific monitoring systems
232. Enterprise architecture management
233. NET DNS-data link WWW.KVA1.COM
234. NET IP address 172.17.75.87
235. GRP area templates; service catalogue
236. GRP template Linux; Apache on Linux
237. OSS Linux server—virtual; Linux server
238. NET IP address 172.x.y.z
239. Middleware instance Apache; Apache
240. NET IP address 172.a.b.c
241. NET service IP port; http Port 80
242. NET service IP port; https Port 443
243. Smart Copy, with adaptation of IP addresses, server names, ports, etc.
244. IT process; client process
245. Process environment production
246. GRP template Linux; Apache on Linux, inserted
247. OSS Linux server—virtual; KV-linux1-v.linux.rz.db.de
248. NET IP address 172.17.83.11
249. NET IP address 172.17.75.87
250. NET service IP port; http Port 8000
251. NET service IP port; https Port 443
252. GRP template Linux; Apache-on-Linux-2,
253. OSS server—virtual; z/OS Host
254. GRP area templates; technical solutions
255. GRP template Windows; information server
256. OSS Windows server—virtual; WindowsServer
257. Process installation basis Windows; process environment
258. Middleware information server; Win-Webserver
259. Application APPL-Doku-Application; documentation system
260. GRP area templates; reference architectures
261. GRP template RefArch; Web-Standard
262. Free
263. GRP template RefArch; Web-Standard; inserted
264. GRP template Linux; Apache on Linux; inserted
265. OSS Linux server—virtual; KV-Linux.Linux.rz.db.de
266. NET IP address 172.12.13.14
267. GRP template Windows; information server; inserted
268. OSS Windows server—virtual; KV-Win.Windowsrz.db.de
269. NET IP address 172.14.13.15
270. NET IP address 172.15.13.16
271. NET service IP port; Http Port80
272. Middleware MW—miscellaneous; Spez-Doku system; inserted

1. A method for the overall handling of an IT process, comprising a complete environment consisting of clients, servers, middleware components, applications and network components that an end user requires for carrying out a specific IT-supported business process, wherein the information required for describing the topology of the IT process is made available in at least one structure tree, as well as prepared and further processed
in order to determine the installation tasks and/or
in order to automatically carry out the installation of IT components and/or
in order to configure and/or set up monitoring systems for monitoring individual IT elements and/or
in order to configure and/or set up service-oriented monitoring systems and/or
for the system planning and/or
for the capacity management and/or
for the commercial analysis and/or
for the commercial quality assurance and/or
for the technical quality assurance and/or
for the creation of change orders for the change management and/or for billing purposes and/or
for use in an Enterprise Architecture Management,
wherein a meta-structure is used for the structure tree and generically defines which IT process element types are permissible, which attributes are permitted and/or required for the IT process element types, which relations between the IT process element types are possible and which attributes are permitted and/or required for the relations, wherein the formalism of the meta-structure only permits distinct and loop-free topological relations between the IT process elements in that a meta-structure in the form of an acyclically directed graph is used that starts at a root element and all child elements are organized under their respective parent elements, and wherein the child elements in turn can only be parent elements of such elements that on their part are not a parent element of these child elements.

2. The method for the overall handling of an IT process according to claim 1, wherein
unique elements, the names of which are contained exactly once in the topology of the meta-structure, are used in the topology of the meta-structure,
non-unique elements, the proper names of which are contained more than once in the topology of the meta-structure, but the complete name of which is distinctly characterized in that it is respectively formed by linking the proper name with the name of the superordinate parent element during its generation, are used in the topology of the meta-structure,
primary relations between parent and child elements are defined, wherein a child of a primary relation exist in the topology as long as the last primary relation with this child is also removed,
secondary relations between parent and child elements are defined, wherein
a. secondary relations can only be established with child elements that are already set up and
b. secondary relations can only refer to child elements if the child element has at least one primary relation,
the meta-structure respectively permits only one primary relation or one secondary relation between two element types
attributes can be assigned to each element contained in the structure tree, and
attributes can be assigned to each relation contained in the structure tree.

3. The method for the overall handling of an IT process according to claim 2, wherein the data links are modeled as secondary relations in the meta-structure in that they are set up
between one respective sender instance and at least one receiver instance or
between one respective “designated data link” that can be identified as a separate element and may be the child element of several sender parent elements and at least one receiver instance.

4. The method for the overall handling of an IT process according to claim 2, wherein
a. grouping elements are modeled by means of unique or non-unique elements,
b. a separate branch is created in the structure tree for each group illustration, and
c. elements from different group illustrations may be linked within the structure tree by means of primary and/or secondary relations.

5. The method for the overall handling of an IT process according to claim 1, wherein
a. software developed during the course of the design of an IT application is developed with the aid of a standardized software modeling language and the information contained in the software modeling is used as a master template for creating the course structure of the structure tree and/or other reference structures and/or technical solutions formulated in a standardized modeling language are used as master template,
b. only services that are contained in a database-supported service catalog are offered during the course of the offer preparation by utilizing the structure defined under a), wherein the cost-determining factors quantity, service parameters and types of service elements to be used are specified in the offer,
c. each ordered IT process is respectively set up in the meta-structure as an individual release within an IT process group by utilizing non-unique elements,
d. each usable platform instance is set up in the meta-structure within at least one IT platform group, and
e. exactly one concrete platform instance from d) subsequently is respectively assigned to all process elements of the IT process branches created in c) by means of secondary relations.

6. The method for the overall handling of an IT process according to claim 5, wherein Regular Expressions that restrict the input options are defined for the manual acquisition of information.

7. The method for the overall handling of an IT process according to claim 6, wherein the number of selectable values is restricted during the manual acquisition of values for proper names and/or attributes of elements that can be selected from a large table in that all superordinate information that is acquired in the path of the structure tree and can be used as conditions for the selection of the values are combined into an overall condition by means of an AND operation and only the values for the acquisition that fulfill the overall condition are subsequently offered for the selection.

8. The method for the overall handling of an IT process according to claim 5, wherein all elements, attributes, primary and secondary relations are imported in order to automatically acquire information by reading in suitably formatted mass data structures underneath a distinct node element, the relations and meta-types are then checked with respect to their validity and the entire import process is either aborted if they are determined to be invalid or, if only secondary relations are concerned, an error list is prepared, in which all invalid secondary relations are listed and subsequently checked by the user.

9. The method for the overall handling of an IT process according to claim 5, wherein an already acquired substructure can be duplicated with a suitable copy function and inserted at another suitable location of the structure tree, and wherein
all relations within the duplicated part are preserved,
only the proper names and attributes of the duplicated elements can be subsequently adapted,
elements that are merely Incorporated into the duplicated subtree by means of secondary relations cannot be edited and
all meta-model relations are checked with respect to their validity prior to the insertion of the copied subtree and the copying process is not physically carried out until complete conformity with the meta-model has been established.

10. The method for the overall handling of an IT process according to claim 1, wherein
attributes are set up in the process structure tree for known data link elements that lead to elements of a cluster and said attributes define threshold values, beginning at which the failure of a number of these cluster elements that is defined by the threshold value is evaluated as critical in a service-oriented monitoring process, and
the monitoring tools for individual elements that should be monitored by themselves are set up as child of the element to be monitored and each monitoring task is respectively set up as child of the corresponding monitoring tool, and wherein the individual monitoring tasks respectively contain a machine-readable illustration of the monitoring task and the description of the corresponding handling instruction and/or error recovery scripts.

11. The method for the overall handling of an IT process according to claim 1, wherein business processes of the user are assigned to the applications in the form of child elements in the process structure tree and one or more active end-to-end monitoring tools and/or functional monitoring systems in turn can be assigned to said business processes of the user in the form of child elements, and wherein monitoring tasks and/or handling instructions can be assigned to the active end-to-end monitoring tools, as well as to the functional monitoring systems.

12. A method for exporting part of a structure tree according to claim 1 in a file format that supports the illustration of hierarchically structured data, wherein in elements that were set up in the meta-structure with a corresponding attribute
all elements set up in the subtree in the downward direction thereof up to the end point element are exported with the corresponding relations beginning with the export start element and
all elements that are linked with the end point element in the upward direction of the tree either by means of all corresponding relations or only the corresponding primary relations are also exported beginning at the end point of the subtree.

13. A method for planning and implementing an upgrade for an IT process by utilizing structure trees according to claim 1, wherein
a. the structure tree of the existing release is exported in a file format that supports the illustration of hierarchically structured data,
b. the structure tree of the planned release is created and also exported in a file format that supports the illustration of hierarchically structured data, and
c. the files created in a) and b) are compared by a data processing system and the results of the comparison are output in structured form, wherein it can be detected
whether an element with all its attribute is changed during the upgrade,
which elements are deleted during the upgrade,
which relations are deleted during the upgrade,
which elements were supplemented during the upgrade, and
which relations were added during the update.

14. A machine-readable storage medium with machine-readable control signals that can cooperate with a programmable computer system in such a way that a method according to claim 1 is carried out.

15. A computer program product with program code that is stored on a machine-readable medium for carrying out a method according to claim 1 when the program product is executed on a computer.
